(19) United States
(12) Patent Application Publication
(10) Pub. No.: US 2006/0136307 A1
(43) Pub. Date: Jun. 22, 2006

(54) Publication system

(76) Inventors: James Jeffrey Hays, Redondo Beach, CA (US); Kenneth R. Moss, Laguna Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/287,477

(22) Filed: Nov. 23, 2005

Related U.S. Application Data
(60) Provisional application No. 60/630,905, filed on Nov. 24, 2004.
(60) Provisional application No. 60/648,095, filed on Jan. 28, 2005.
(60) Provisional application No. 60/729,691, filed on Oct. 24, 2005.

(51) Int. Cl. G06Q 30/00; G06F 17/24; G06F 3/00

(52) U.S. Cl. 705/26; 715/764; 715/530

(57) ABSTRACT

A network-based system that provides functionality for controlling the content of printed menus includes an electronic data repository and a web-based application program. The electronic data repository contains descriptions of content items that may be selected to include within printed items. The electronic data repository also contains a set of rules that specify, at least, specific content items that are required. The web-based application program allows a user to interactively create a printed item that includes selected content item descriptions from the data repository, and to place an order for printed copies of a created printed item. The web-based application inhibits the creation of printed items that do not comply with the set of rules.

### RELATED APPLICATIONS

The present application claims priority from U.S. Provisional No. 60/630,905, filed Nov. 24, 2004, U.S. Provisional No. 60/648,095, filed Jan. 28, 2005, and U.S. Provisional No. 60/729,691, filed Oct. 24, 2005, all of which are incorporated herein by reference.

### BACKGROUND

1. Field of the Invention

The present invention relates to devices, systems, and methods for printing and/or publishing.

2. Description of the Related Art

Traditional online printing services have provided users with limited, basic printing and customizing functionality. For example, service providers such as Bizlnk (www.bizink.com) allow users to order print materials online and track orders. Bizink allows its users a limited ability to customize print materials and view proofs online.

Similarly, traditional online printing services have allowed a user to design a print article online by selecting a template and entering data corresponding to particular fields within the template. For example, Printingforless.com (www.printingforless.com) allows its users to select a business card template, select a background color, text color and font size, and then enter the user's name, title, business name, address, telephone number, fax number and other text-based information. An image of the final business card is provided over the Internet to the user. If acceptable to the user, the user can then order printed copies of the business card.

However, there is still a need for users to be able to totally customize printed articles and to control customization by using a rules-based approach to print management. In addition, there is a need for a print system that is capable of providing additional accounting, inventory management (including production and shipping), reporting and data mining functionality.

### SUMMARY

One aspect of the present invention involves a network-based system that provides functionality for controlling the content of a printed article, which includes an electronic data repository and a web-based application program. The electronic data repository contains content elements that may be selected to include within printed articles, and contains a set of rules that specify, at least, specific required content elements. The web-based application program provides functionality for a user to interactively create a printed article that includes selected content elements descriptions from the data repository, and to place an order for printed copies of a created printed article. The web-based application inhibits the creation of printed articles that do not comply with the set of rules.

Another aspect involves a method of controlling the content of a printed article, which includes providing an electronic data repository that contains content elements that may be selected to include a printed article; providing a set of rules that specify, at least, specific required content elements; receiving a selection of at least one of the content elements; determining if said selection complies with the set of rules; and generating a data file corresponding to the printed article when said determining indicates that the selection complies with the set of rules.

Another aspect involves a method of collecting and aggregating print orders, which includes: retrieving a template corresponding to the printed article, wherein the template includes a plurality of fields that corresponds to the at least one fixed content element and the at least one variable content element; receiving the at least one fixed content element and the at least one variable content element; searching a database for an existing version corresponding to the at least one variable content element; creating a new version within the database when the existing version is not found, wherein the new version corresponds to the at least one variable content element; and updating a production quantity associated with the existing or new version.

Another aspect involves a method of automatically aggregating orders for printed articles, which includes: receiving a first order for a first printed article, wherein the first printed article comprises a first set of content elements; receiving a second order for a second printed article, wherein said second printed article comprises a second set of content elements; comparing said first and second sets of content elements; and programmatically aggregating said first and second orders when said first and second sets of content elements are substantially identical.

Another aspect involves a network-based system that provides functionality for controlling the content of a printed article, which includes an electronic data repository, a web-based application program, and an analysis engine. The electronic data repository contains content elements that may be selected to include within printed articles. The web-based application program provides functionality for a user to interactively create a printed article that includes selected content elements from the data repository and to provide order entry data for printed copies of a created printed article. The analysis engine program generates report data based at least in part on said order entry data and provides a report comprising said report data upon request from a user.

Another aspect includes a method of automatically aggregating orders for printed articles, which includes: receiving a first order for a first printed article, wherein the first order comprises an associated first production completion date and first shipping destination; receiving a second order for a second printed article, wherein the second order comprises an associated second production completion date and second shipping destination; comparing said first and second shipping destinations; and programmatically coordinating a production schedule associated with said first and second orders such that the first and second production completion dates are about equal when said first and second shipping destinations are equivalent.

### BRIEF DESCRIPTION OF THE DRAWINGS

FIG. 1 is a schematic representation of one embodiment of a publishing network.

FIG. 2 is a schematic representation of a publishing server of the publishing network of FIG. 1.

FIG. 3 is a flowchart illustrating a method of network-based method of document proofing and publishing with the publishing server of FIG. 2.

FIG. 4 is a schematic representation of a printed article that can be produced with the publishing network of FIGS. 1, 5 and 8.

FIG. 4A is a schematic representation of a template used to create the printed article of FIG. 4.

FIG. 5 is a schematic representation of another embodiment of the publishing network of FIG. 1, including a distributed system for collecting and aggregating print orders.

FIG. 6 is a schematic representation of the database of the publishing network of FIG. 5.

FIG. 7 is a flowchart illustrating a method of collecting and aggregating print orders with the network of FIG. 5.

FIG. 8 is a block diagram of a publishing server that can be used with the systems of FIGS. 1 and 5 and that is configured in accordance with a preferred embodiment of the present invention.

FIG. 8A is a block diagram of a rendering system of FIG. 8.

FIG. 9 is a block diagram of a software system of a rendering workstation of FIGS. 8 and 8A.

FIG. 10 is a flowchart of a publishing method able to be performed with the system of FIG. 8.

FIG. 11 is a flowchart of an order processing method able to be performed with the system of FIG. 8.

FIG. 12 is a flowchart of a method of ordering a customizable product able to be performed with the system of FIG. 8.

FIG. 13 is a flowchart of a rendering method able to be performed with the system of FIG. 8.

FIG. 14 is a flowchart of a method of displaying ordered products able to be performed with the system of FIG. 8.

FIG. 15 is a flowchart of a method of processing shipping information able to be performed with the system of FIG. 8.

FIG. 16 is a flowchart of a method of processing billing information able to be performed with the system of FIG. 8.

FIG. 17 is a flowchart of a method of processing an order for multiple locations able to be performed with the system of FIG. 8.

### DETAILED DESCRIPTION

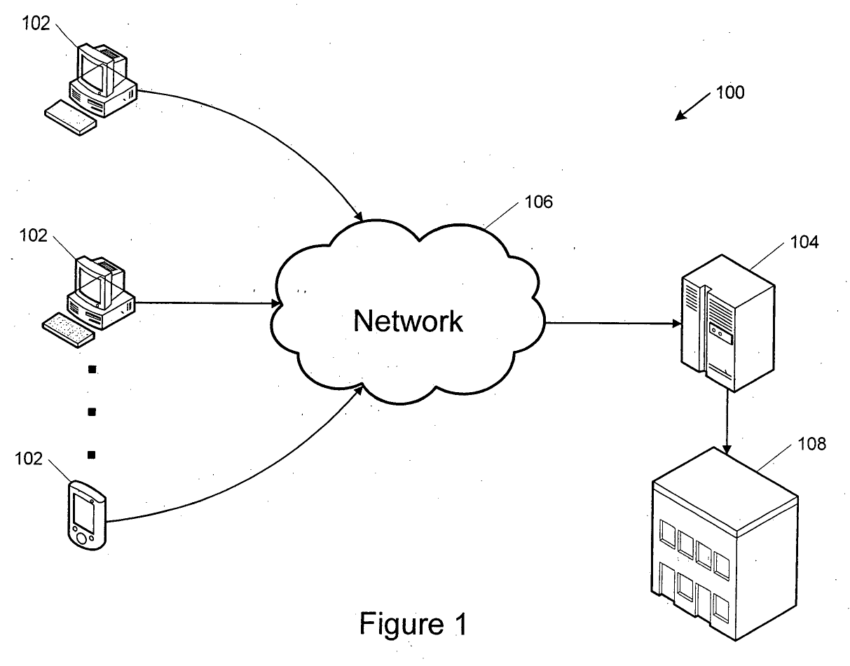

A publishing network 100 in accordance with one embodiment of the present invention is schematically illustrated in FIG. 1. In this embodiment, the publishing network 100 includes at least one client 102 in communication with a publishing server 104 via a network 106. The publishing server 104 preferably communicates with a publisher 108, either directly or indirectly. Although the publishing server 104 and publisher 108 are illustrated as separate elements of the publishing network 100, it should be understood that the publishing server 104 may in fact be located within, or be an integral part of the publisher 108, or vice versa.

In one embodiment, the client 102 is a personal computer, but may be any other data input device suitable for communication via the network 106. For example, the client 102 may be a terminal, a personal digital assistant (PDA), a telephone, a cellular telephone, or any other such device, as is well known to those of skill in the art.

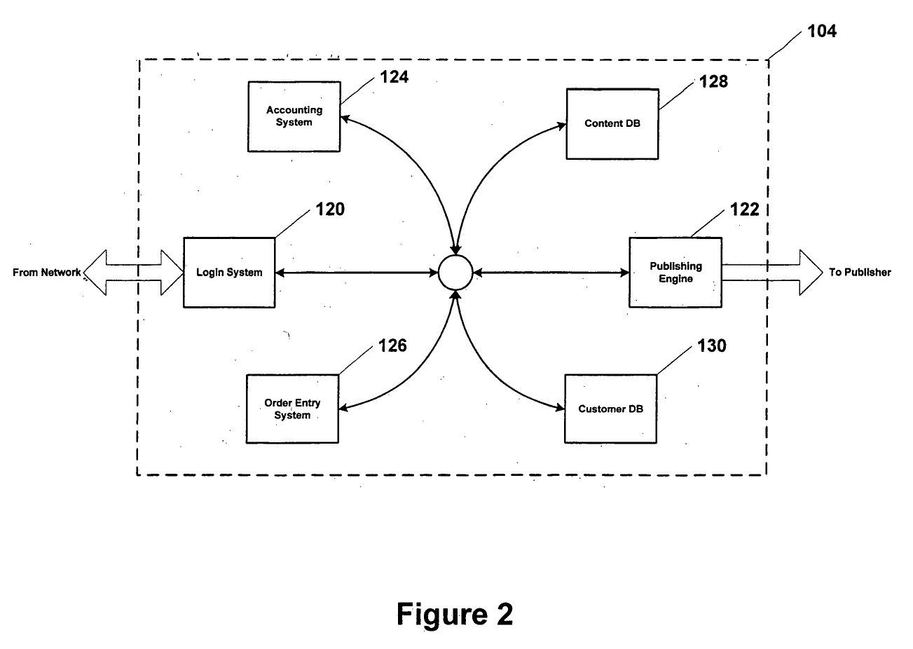

The publishing server 104 is generally a computer, such as a server, but may be any device capable of executing a software program or other logic steps, and able to communicate with client 102 over a network 106. The publishing server 104 generally includes several sub-systems and modules that operate together, and will be discussed in greater detail below with respect to FIG. 2.

Network 106 is any network over which clients 102 and publishing servers 104 can communicate with one another. For example, in one embodiment, the network 106 is the Internet. In other embodiments, the network 106 is a local area network (LAN), a wide area network (WAN), or a direct connection between a terminal and a server. The network 106 may be configured to have any of a variety of network topologies or architectures. For example, the components of the network 106 may be connected in a mesh, star, bus, ring, or tree topology. In another embodiment, the network includes a combination of two or more topologies, such as groups of star-configured networks connected to a linear bus backbone.

In one embodiment, the publisher 108 is a device or system for converting digital data provided by the publishing server 104 to a printed object that represents the digital data. For example, the publisher 108 may be a paper publishing facility that prints documents, including advertisements, marketing materials, poster, brochures, pamphlets, labels, letters, artwork, direct mail, posters, signs, print on demand articles, photographs or any other printable object from digital data provided by a publishing server 104. The publisher 108 may also create non-paper objects from the digital data, for example, mugs, pens, shirts, buttons, etc. In some cases, the publisher 108 is a contractor that receives and processes print orders. For example, the publisher 108 can be a separate contractor that receives print orders and distributes the orders to additional publishers for print product production.

The publishing server 104 preferably includes several sub-systems that process information received from the network 106 and that generate a data file that is provided to the publisher 108. As illustrated schematically in FIG. 2, the publishing server 104 includes a login system 120, a publishing engine 122, an accounting system 124, an order entry system 126, and at least one database. For example, the publishing server 104 may include a content database 128 and a customer database 130, although any of a variety of databases and data structures and hierarchies may be utilized, as will be appreciated by those of skill in the art.

The subsystems preferably are integrated with one another so as to seamlessly transfer various data and to interact with one another. The subsystems may include various compatible systems or commercially available software modules known to those of skill in the art (e.g., the Macola software system produced by Exact Software North America, Inc., or the Web.Orders software product produced by Macola Software). Alternatively, inter-subsystem data transfer and interaction may occur between customized interfaces, systems and/or software modules, or between a combination of customized and commercially available software systems.

In addition, the various subsystems illustrated in FIG. 2 can include software, hardware, firmware or a combination of software, hardware, and firmware components. In some cases, the subsystems are computers or servers configured to execute software programs designed to implement the functionality required by each of the particular subsystems. In other cases, the subsystems are software modules designed to work with each of the other subsystems.

Although each of the various subsystems is adapted to communicate with each other subsystem, in one embodiment, certain subsystems preferably communicate with only certain others. For example, the login system 120 may communicate with an accounting system 124 and a customer database 130; the accounting system 124 may communicate with the order entry system 126 and the customer database 130; and the order entry system 126 may communicate with content database 128 and the publishing engine 122.

In the illustrated embodiment, a client 102 establishes a communications link with the publishing server 104 via the Internet through a browser, such as a web browser. The login system 120 of the publishing server 104 prompts the client 102 for login information, which may include a user ID and a password. The login system 120 implements security checks and authenticates the identity of the client 102 by using any of a variety of methods well known to those of skill in the art. The functionality provided by the publishing server 104 may be provided via active server pages (ASP), such that code executed by the publishing server 104 resides within the publishing server 104, and is not transferred to the client 102.

Once logged-in to the publishing server 104, the client 102 may select content from a content database 128 for editing and/or printing. The content database 128 contains a variety of digital information and data files, including photographs, layouts, menus, templates, copy, and combinations thereof. The publishing server 104 controls client 102 access to content within the content database 128 based upon the identity and/or user-privileges of the particular client 102. For example, in one embodiment, a first client 102 is permitted access to a first set of photographs, layouts, menus and copy located within the content database 128, and a second client 102 is permitted access to a second set of content.

The identity of the client 102 preferably is authenticated by comparing log-on information to information stored within a customer database 130. Customer database 130 information may include a user ID, password, shipping address, billing address, phone number, fax number, email address, as well as any other contact or customer-related information.

In the illustrated embodiment, the client 102 places an order for selected content via the order entry system 126. The order entry system 126 provides the client 102 with a selection of content from the content database 128. The client 102 may then select individual content or combinations thereof to be sent from the publishing server 104 to the publisher 108. For example, in one mode of operation, the client 102 places an order via the order entry system 126 for POP marketing materials (e.g., sales and marketing materials, displays, buttons, premium items, posters, flyers, banners, brochures, or any other such printable item) that include artwork from the content database 128, as well as text. The text content may be selected from the content database 128, or may be input by the client 102 via the order entry system 126.

The order entry system 126 then communicates the order with an accounting system 124, which provides additional information to the client 102 via the order entry system 126. The accounting system may be any system, such as a software program, that accesses accounting and production information. For example, in one embodiment, the accounting system 124 provides pricing information, estimated production time, estimated delivery time, and any other accounting or production data to the client 102. In addition, in one embodiment, the accounting system 124 maintains data related to production, inventory, supplies, labor, procurement, accounts payable, accounts receivable, billing, and collections for use by a publishing server administrator. Such information may be used by the administrator to generate invoices and reports that indicate productivity and/or profitability of the publisher 108. In one embodiment, the accounting system 124 provides billing information to the client 102 to enable processing of a print order.

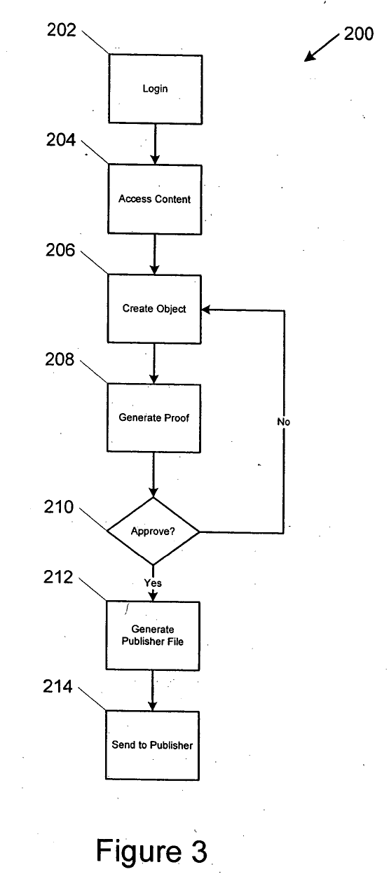

Once the content has been selected by the client 102, the client may request that a proof be generated so that the client 102 may confirm the content, layout, and/or quality of the selected article. In response to the request, the publishing engine 122 generates a proof, which in one embodiment is a low-resolution image that corresponds to the final appearance of the selected article. The proof is sent to the client 102 for approval. Additional description of generating a proof is described in greater detail below with respect to FIG. 3. When the proof is approved, the publishing engine 122 generates a digital file that may be transmitted to a publisher 108 for printing.

One embodiment of a method of network-based document customizing, proofing and publishing 200 is illustrated in FIG. 3. In this embodiment, at step 202, a client logs on to the publishing server and provides a user ID and password. At step 204, the client is granted access to content from a content database. At step 206, the client is prompted to create a printable object. The printable object may be any object capable of being printed, such as, a poster, menu, letter, advertisement, brochure, pamphlet, marketing material, button, pin, pen, mug, shirt, etc. The printable object may be created from elements that are stored in the content database, or are uploaded, entered, or otherwise provided by the client. In one embodiment, the elements include art, an image, copy, a photograph, a logo, a menu entry, a map, an illustration, a drawing, any text entries, or any other printable object, material, or information. A text entry may include a price, a time, a date, a description, an address, etc.

Printable objects may be customized during step 206 by selecting or entering the desired elements as described above. In one embodiment, the printable object includes a template that contains data fields into which selected or inputted objects or text are placed. For example, the printable object may include a sales brochure, which includes a layout template, a background, artwork elements and text elements. In the embodiment, the layout template defines the dimensions and processing parameters associated with the production of the printable object, the background artwork (if any), and various fields into which artwork elements and/or text elements may be selected and entered.

The client may select the artwork and text elements that appear in the various fields by any of a variety of methods. For example, in one embodiment, the client uploads an artwork element or inputs text to the publishing server, which inserts it in the appropriate field. In another embodiment, the client selects the artwork element or text from a menu, such as a pull-down menu, or any other catalog of artwork or text stored in the content database. Control over client access to content stored in the content database is controlled at least in part by the login system, as described above.

After an object is created, a proof is created at step 208. In one embodiment, the proof includes an on-screen display of an image (for example, a low-resolution image) that corresponds to the final object to be printed by the publisher. For example, in one embodiment, the proof includes a portable document format file (.pdf file) generated by an Adobe portable document file engine, such as the program titled, In Design, and manufactured by Adobe Systems, Inc.

At step 210 the client is prompted to approve the proof. If the client does not approve the proof, the method 200 returns to step 206, where the object may be edited or changed. If the client does approve the proof, the method 200 proceeds to step 212, during which the publishing engine produces a data file that may be processed by a publisher. In one embodiment, the data file is a high-resolution .pdf file, and in another embodiment, the data file is an encapsulated postscript (e.g., .eps) file. It will be understood by those of skill in the art that any of a variety of graphical format files may be used, including: Adobe Illustrator, Adobe Photoshop, Atari ST Graphics Formats, AutoCAD DXF, Autodesk 3D Studio, BDF, BRL-CAD, BUFR, CALS Raster, CGM, CMU Formats, DKB, Dore Raster File Format, DPX, Dr. Halo, DVM Movie, Encapsulated PostScript, FaceSaver, FAX Formats, FITS, FLI, GEM Raster, GEM VDI, GIF, GRASP, GRIB, Harvard Graphics, Hierarchical Data Format, IFF, IGES, Inset PIX, Intel DVI, JPEG File Interchange Format, Kodak Photo CD, Kodak YCC, Lotus DIF, Lotus PIC, Lumena Paint, Macintosh Paint, Macintosh PICT, Microsoft Paint, Microsoft RIFF, Microsoft RTF, Microsoft SYLK, Microsoft Windows Bitmap, Microsoft Windows Metafile, MIFF, MPEG, MTV, NAPLPS, NFF, OFF, OS/2 Bitmap, P3D, PBM, PGM, PNM, and PPM, PCX, PDS, Pictor PC Paint, Pixar RIB, Plot-10, PNG, POV, Presentation Manager Metafile, PRT, QRT, QuickTime, Radiance, Rayshade, RIX, RTrace, SAF, Sense8 NFF, SGI Image File Format, SGI Inventor, SGI YAODL, SGO, SPIFF, Sun Icon, Sun Raster, TDDD, TGA, TIFF, TTDDD, uRay, Utah RLE, VICAR2, VIFF, VIS-5D, Vivid and Bob, Wavefront OBJ, Wavefront RLA, WordPerfect Graphics Metafile, XBM, XPM, XWD, or ZBR.

Finally in step 214, the data file is transmitted from the publishing server to the publisher. The publisher receives the data file and processes it to create the quantity of objects selected by the client. In addition, in one embodiment, the publishing server bills the client and provides shipping information to the publisher so that the printed objects may be readily shipped to the client. Alternatively, the data file can be generated by the publisher, for example, after receiving approval of a proof provided by the publishing server to the user.

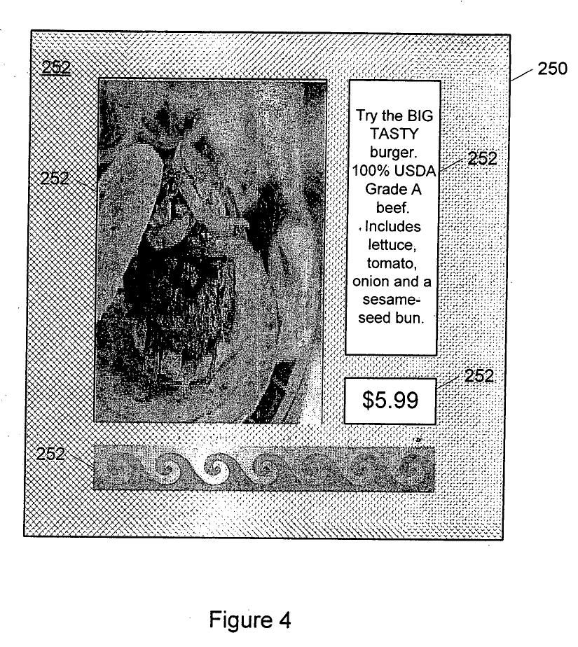

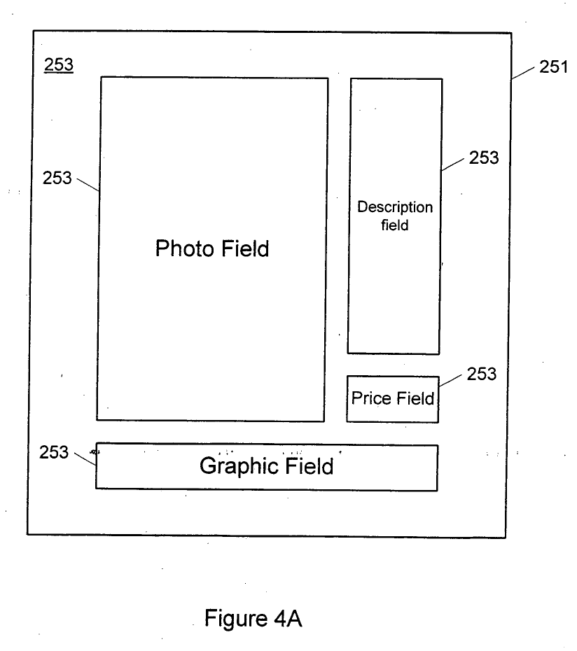

A printed article 250 that can be produced in accordance with one embodiment of the present invention is illustrated in FIG. 4. In some embodiments, the printed article 250 is any advertising, marketing material, a catalog, or a menu. For example, the printed article 250 may include a “table-topper”, a menu handout, a “dangler”, a button, a poster, a “cling”, and/or a banner. “Table-toppers” include advertising or marketing materials placed on the tables in restaurants. Menu handouts generally include single-sided or double-sided sheets of advertising material that are inserted inside of and provided with menus at restaurants. “Danglers” include signs that hang from the ceiling of retail stores and restaurants. “Clings” include marketing materials that have at least one adhesive surface and are partially transparent so that they may be attached to the inside or outside of the windows of restaurants or retail establishments.

In one embodiment, the printed article 250 includes at least one content element 252. The content element 252 is any textual, pictorial, or graphical element or hybrid thereof, used to create a printed article 250. For example, in one embodiment, the content element 252 includes a color, a design, a template, a graphic, a background, a layout, a photograph, or text. The text may include copy or wording, such as item descriptions, up-sell text, a price, a date, or any other text. In the exemplary embodiment of FIG. 4, printed article 250 includes four content elements 252: a photograph, description of the photographed item, a price, and a graphic.

A template may be used to create the printed article 250 with the publishing system 270, as described in greater detail below. An embodiment of template 251 used to create the printed article 250 of FIG. 4 is schematically illustrated in FIG. 4A. Template 251 includes one or more fields 253, any number or all of which can be customizable (that is, changeable by the user). Field 253 includes data structures that are populated with data or information corresponding to particular content elements 252. For example, template 251 of the illustrated embodiment of FIG. 4A includes five fields 253 that correspond to the photograph, menu item description, price, graphic, and background pattern and color of content elements 252 of FIG. 4.

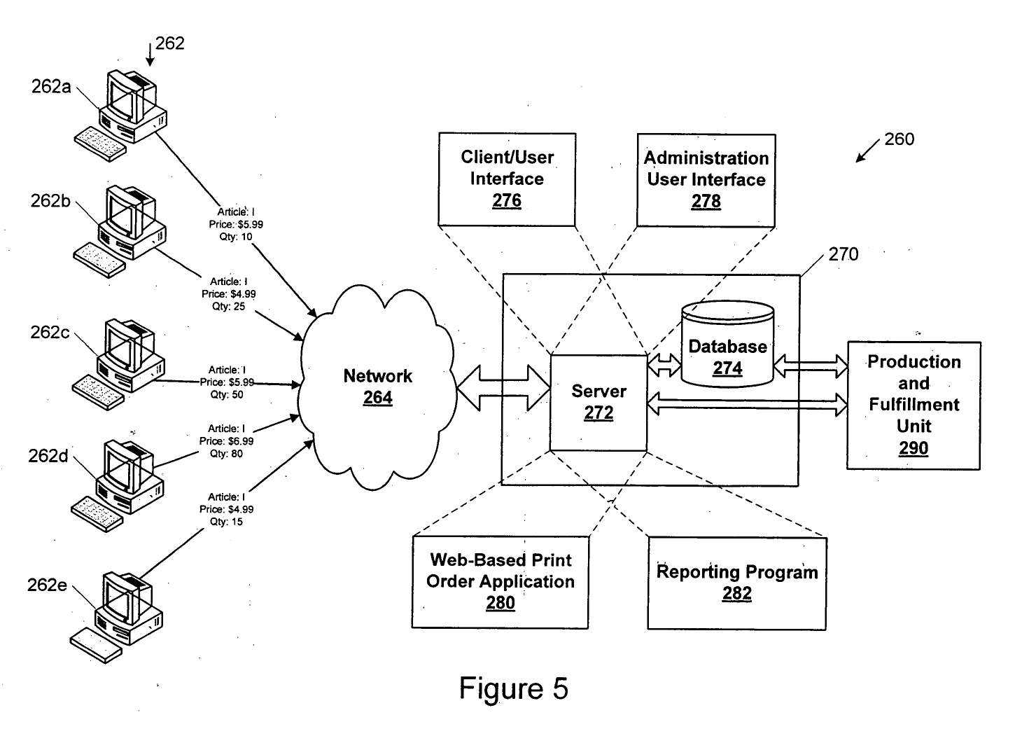

A system user can create the printed article 250 by selecting a corresponding template 251 from a database, as discussed below. The user then selects content elements 252 from the database, uploads or enters them directly into the system. The content elements 252 are selected to populate the various fields 253 of the template 251. After the fields 253 are populated, the system provides a graphical representation of the printed article 250. If the graphical representation is acceptable to the user, an order is placed with a printed article production facility, such as publisher 108 and/or production and fulfillment unit 290, as discussed in greater detail herein, particularly with respect to FIGS. 1 and 5. The order may be place directly with the production facility or indirectly via an intermediary.

FIG. 5 illustrates a publishing network 260, which is of the general type illustrated in FIG. 1, that is configured and is operated to efficiently produce customizable printed articles such as, for example, the printed article 250 illustrated in FIG. 4. As seen in FIG. 5, the publishing network 260 includes multiple users 262 in communication with a system 270 via a network 264. Although any number of users 262 may access the publishing network 260, the illustrated embodiment includes five users 262a, 262b, 262c, 262d, and 262e.

In the illustrated embodiment, the system 270 includes a server 272 and a database 274. Server 272 is in communication with the network 264, the database 274, and a production and fulfillment unit 290. The server 272 preferably includes a client/user interface 276, an administration user interface 278, and a web-based print order application 280. The database 274 is in communication with the production and fulfillment unit 290 as well.

As illustrated in FIG. 5, the users 262 can order articles, such as printed articles 250, through the publishing network 260. In the illustrated embodiment, provided as an example only, all users 262 order the same printed article 250, a “table-topper” designed to market a hamburger includes content elements 254 similar to the printed article 250 illustrated in FIG. 4. In the present example, the printed article 250 includes four content elements 254 that may not be modified by the user 262 and one content element 254 that may be customized by the user 262. Which fields are fixed and which fields can be modified/customized by the user will vary for article to article and will be defined by the administrator, as described in further detail below.

The content elements 254 that are fixed, and cannot be modified or customized by the user, have corresponding fields 253 that are automatically populated with pre-determined content elements 254 when the “table-topper” article 250 is selected. For example, the fixed content elements in this example are the photograph of the hamburger, the written description, the graphic, and the background color and pattern of the “table-topper”. A content element that may be customized by a user 262 is sometimes referred to as a variable content element. In the illustrated example, the customizable, variable content element 252 is the hamburger's price. The user provides the price to be printed on the “table-topper” by entering the desired price into the field 253 associated with the price content element 254 with the system. In some cases, a content element 254 is partially customizable or partially variable. For example, the user 262 can be provided a list of choices of graphical and/or text elements that can be selected to populate the fields 253 associated with a printed article 250. A user 262 can be provided with four pricing options for a particular menu item, and the selected price can be used to populate a pricing field 253 of a printed article 250.

In the exemplary embodiment illustrated in FIG. 5, each user 262 places an order for the same article (Article I, in this example, a “table-topper” designed to market a hamburger). In addition, each user 262 customizes the article based on its particular requirements. For example, each user specifies a particular price to be printed on its articles. In addition, each user 262 provides an order quantity for each printed article 250.

In the illustrated embodiment, the system 270 receives the orders from the individual users 262 and groups and consolidates them to improve production efficiency. Orders for customized articles 250 preferably are assigned a version number specific to the article and customization provided by the user 262. For example, orders for Article I that are to display a price of $5.99 are referred to as Version 1; orders for Article I that are to display a price of $4.99 are referred to as Version 2; and orders for Article I that are to display a price of $6.99 are referred to as Version 3. Additional details regarding assigning version numbers to customized orders is provided in greater detail below. Orders for the same Version of Article by multiple users 262 are aggregated, consolidated, or combined to provide the article manufacturer with an order for a larger quantity of goods. Orders for larger quantities of goods generally decrease production costs and increase production efficiency by eliminating multiple set-up, tooling (e.g., creation of printing plates), and other fixed costs.

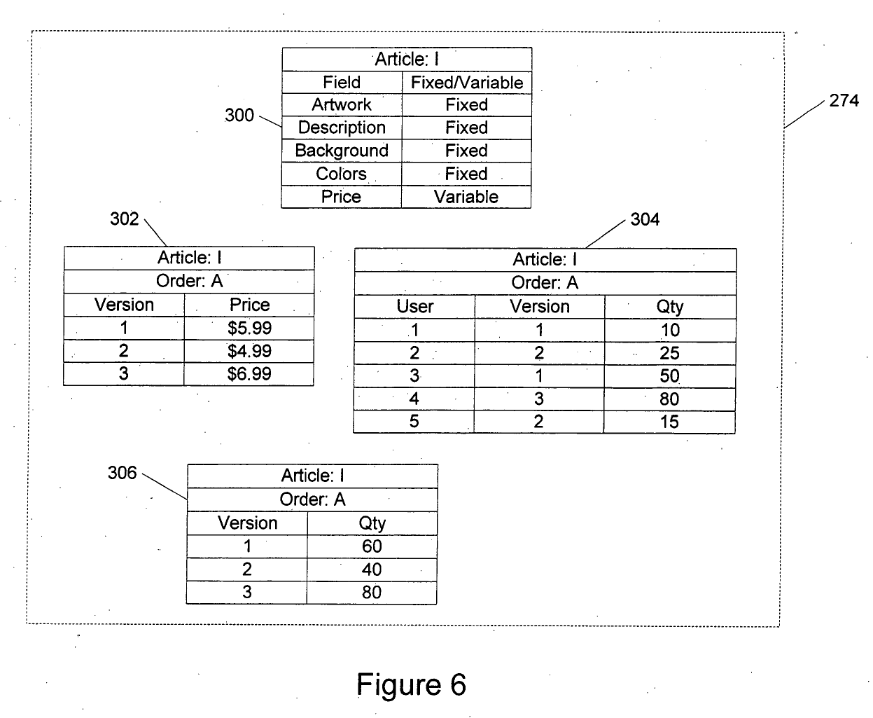

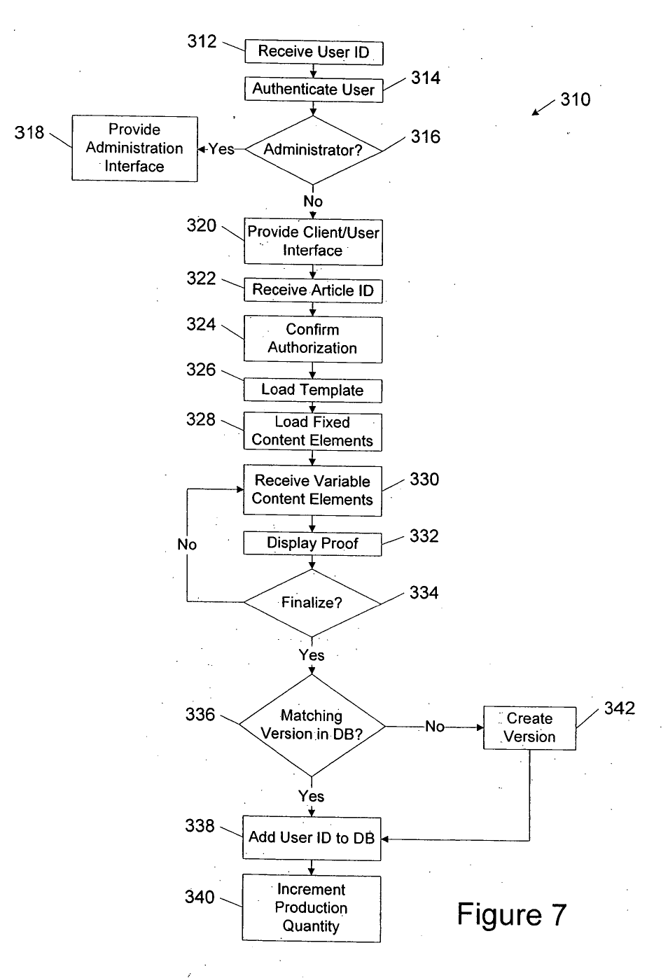

For example, in the present embodiment, user 262a and user 262c place an order for the same version of Article I. Subsequently, the system 270 combines their orders to reduce production costs. Additional details regarding order aggregation, consolidation and optimization are provided in greater detail below with respect to FIGS. 6 and 7.

The publishing network 260 of FIG. 5 is one embodiment of the publishing network 100 described in greater detail above with reference to FIGS. 1 and 2. The users 262 of FIG. 5 include any person, entity or machine capable of ordering a printed article with publishing network 260, and can also be the clients 102 described in greater detail above with reference to FIGS. 1 and 2. Network 264 is any communications network suitable for communication between users and electronic systems, such as system 270. The network 264 can be a wired network, a wireless network, or a combination thereof. The network 264 can be the network 106 described in greater detail above with reference to FIGS. 1 and 2. In one embodiment, network 264 is the Internet.

System 270 includes any system known to those of skill in the art for communicating with users over a network 264. In one embodiment, system 270 includes a computer, a workstation, a server, a database and/or other hardware and software components known to those of skill in the art.

Publishing server 272 is generally a computer including a server but may be any device capable of executing a software program and able to communicate with users 262 over a network 264. The server 272 generally includes several subsystems and modules, including hardware, software, firmware and combinations thereof that operate together. The server 272 may be one embodiment of the publishing server 104 described in greater detail above with reference to FIGS. 1 and 2.

The database 274 is a hardware or software component capable of storing information. In one embodiment, the database 274 is a relational database having one or more data tables. One embodiment of a database 274 is illustrated and described in greater detail below with reference to FIG. 6. The database 274 may include a content database 128 and/or customer database 130, as described in greater detail above with respect to FIG. 2.

In one embodiment, client/user interface 276 is a software interface viewed by the user 262 when accessing the system 270 over the publishing network 260. The client/user interface 276 includes web-based applications, browser windows, text and graphics, that in one embodiment are adapted to prompt users 262 for variable content element 252 values and to provide visual representations computer-generated proofs (e.g., pre-production images) of printed articles 250. The client/user interface 276 may be adapted to perform the method 200 described above with respect to FIG. 3.

The administration user interface 278 can include the software and visual elements used by a user 262 having administration-level privileges. In this embodiment, a user 262 with administration-level privileges is able to configure the operation of the system 270, the server 272, the database 274, client/user interface 276, administration user interface 278, and/or web-based print order application 280. Administration-level users often are able to provide a rule set that controls the ordering experience, the interface and/or customization control provided to users 262 when utilizing or accessing the publishing network 260. Additional details regarding the administration user interface and rule specifying functionality are provided in greater detail below.

The web-based print order application 280 can prompt the users 262 for information and receive orders for printed articles 250. One embodiment of the functionality of a web-based print order application 280 is provided below and is described with respect to FIG. 7.

The production and fulfillment unit 290 may be a device or system for converting digital data provided by the system 270 to a printed article 250. For example, the production and fulfillment unit 290 can be a print shop capable of receiving orders from system 270 and creating printed articles 250. In one embodiment, production and fulfillment unit 290 is the publisher 108 described in greater detail above.

One embodiment of a database 274 is illustrated in FIG. 6. The exemplary, illustrated database 274 includes four individual sub-databases or tables, although any number of individual databases, sub-databases, tables, or combinations thereof may be utilized. The illustrated database 274 includes an article content database 300, a version database 302, an order/fulfillment database 304, and a production database 306.

When a user 262 places an order for an article, the system 270 accesses article content database 300 to determine the content elements 252 associated with the ordered article. For example, when the article is the exemplary printed article 250 described above, which has only one variable content element 252, the associated article content database 300 may appear as illustrated in FIG. 6.

For example, in the present embodiment, the printed article 250 that has been ordered is referred to as “Article: I,” corresponding to the “table-topper” for marketing a hamburger, described above with respect to FIGS. 4 and 4A. The printed article 250 includes five content elements 252: a photograph, a description, a background, a design graphic, and a price. The “table-topper” printed article 250 has an associated template 251, which includes five fields 253: one for each of the five content elements 252. All content element fields 253 are fixed (e.g. not customizable by the user) except for the price content element field 253. For example, this means that the user 262 may only change the value of the price to be printed on printed article 250; the user 262 may not change the artwork, description, background, and colors to be printed on printed article 250. In other embodiments, more than one content element 252, or all content elements 252 are customizable by a user. The content element 252 may be customizable to a particular user 262 based upon a rule set and/or upon access privileges or rights assigned to the particular user 262.

After the user 262 provides a price to be printed on the ordered printed article 250, the system 270 accesses version database 302 to retrieve an associated version number. If the price provided by the user 262 has already been recorded in the version database 302, the associated version number is retrieved. If, however, the price has not been provided to the version database 302, the price is added to the version database 302 and a new version number is generated. The version database 302 records all versions associated with a particular printed article 250 and the customized values associated with variable content element 252 fields.

The order/fulfillment database 304 can record orders placed by users 262. For example, in the illustrated embodiment, users 262 place an order for printed Article I (e.g., a “table-topper” for marketing a hamburger), and the orders are recorded as “Order A”. As indicated in the order/fulfillment database 304, and as illustrated in FIG. 5, one user 262a places an order for ten units of Version 1 of Article I; another user 262b places an order for 25 units of Version 2 of Article I; another user 262c places an order for 50 units of Version 1 of Article I; user 262d places an order for 80 units of Version 3 of Article I; and another user 262e places an order for 15 units of Version 2 of Article I.

The server 272 of the system 270 may aggregate and/or consolidate orders to improve production efficiency. For example, as illustrated in FIG. 6, production database 306 is generated and includes the total quantity ordered of each version of Article I in order A. For example, in the present embodiment, since both users 262a and 262c ordered Version 1 of Article I, their order quantities are combined and recorded in the field associated with Version I in production database 306. The same is repeated for Versions 2 and 3 of Article I.

Information from the production database 306 may be provided to production and fulfillment unit 290 so that versions of printed articles 250 can be produced at a greater quantity level than individual orders. The consolidated orders of users 262 are recorded in production database 306 and are provided to production fulfillment unit 290.

The production and fulfillment unit 290 can retrieve production information from production database 306. Production database 306 indicates the particular printed article 250 to be ordered and the quantity requested of each version of that particular printed article 250. For example, in the present embodiment, production and fulfillment unit 290 produces 60 units of Version 1 of Article I, 40 units of Version 2 of article 1 and 80 units of Version 3 of Article I. Once produced, orders are fulfilled by referencing information in order/fulfillment database 304. For example, 10 units of Version I of Article I will be sent to user 262a, 25 units of Version 2 of Article I will be sent to user 262b, and so forth.

One method of aggregating orders and optimizing order fulfillment is illustrated in FIG. 7. At block 312 the method 310 receives a user identification or user ID. At block 314, the method 310 authenticates the user and checks to verify that the user has access privileges to the publishing to the system. The method 310 checks to determine whether the user has administration-level privileges or user-level privileges at block 316. If the user has administration-level privileges, the method 310 continues to block 318 where an administration interface is provided. Administration interface allows the user to customize, configure, and set access privileges to various components of the publishing network, as described in one example above.

If the user does not have administration-level privileges, the method 310 continues to block 320 where a client/user interface is provided. At block 324, the method 310 receives an article ID from the user. At block 326, the method 310 confirms that the user is authorized to access or order the selected article. At block 328, the method 310 loads a template associated with the article ID. In one embodiment, the template may be loaded or retrieved from an article content database, such as article content database 300 described above with reference to FIG. 6.

At block 330, the method 310 loads the fixed content elements from the appropriate database. At block 332, the method 310 receives variable content element data from the user. At block 334, the method 310 displays a proof, or preliminary graphical representation, of the article, which includes the loaded fixed content elements and the user-provided, variable content elements. At block 336, the method 310 asks the user whether he wishes to finalize his order. If the user wishes to make additional changes and does not wish to finalize the order, the method 310 returns to block 332; however, if the user does finalize the order, the method 310 proceeds to block 338.

At block 338, the method 310 accesses a database to determine whether the version provided by the user has already been entered into the system by the same or a different user. For example, in one embodiment, the method 310 accesses the version database 302 described above with respect to FIG. 6. If the version provided by the user does exist, the method 310 continues to block 340 where the user information and order information are provided to a database. For example, the information may be provided to a user/fulfillment database 304, as described above with respect to FIG. 6. The method 310 then continues to block 342, where production quantities are increased according to the order placed by the user. For example, production database 306 as described above with respect to FIG. 6, may be updated to include or to reflect the order information provided by the user.

At block 338, if the version information provided by the user has not already been saved in the database, the method 310 proceeds to block 344, where a version record is stored in the appropriate database. For example, version information may be stored in version database 302 as described above with respect to FIG. 6.

Although the steps of the method 310 have been illustrated as individual blocks, it should be well understood by those of skill in the art that any two or more steps may be combined and performed at the same time, or in parallel. For example, in one embodiment, step 326 and 326 are performed at the same time.

FIG. 5 illustrates one example of a system 270 of a publishing network 260 that provides network-based functionality for controlling the content of printed menus. Although the following exemplary use of the system 270 of FIG. 5 is to generate a printed menu, it is well understood by those of skill in the art that any printed article, including any printed article described herein, can be produced with the system 270 of FIG. 65.

The system 270 can include an electronic data repository, such as database 274. The electronic data repository may contain descriptions of menu items that may be selected to include within printed menus. The electronic data repository may also contain a set of rules that specify, at least, specific menu items that are required.

In another embodiment, the network-based system 270 also includes a web-based application program, such as web-based print order application 280. The web-based application program can provide functionality for a user to interactively create a menu that includes selected menu item descriptions from the data repository. The web-based application program also provides functionality for a user to place an order for printed copies of a created menu. In another embodiment, the web-based application program inhibits the creation of menus that do not comply with the set of rules.

The web-based application includes an administration user interface, such as, for example, administration user interface 278. The administration user interface may provide functionality for an administrator to specify the set of rules. The set of rules can include an access right that may be used to control which of a plurality of users 262 may have access to the system 270, or its sub-systems, modules, databases, software, etc. In another embodiment, the set of rules controls the order in which selected descriptions of menu items are displayed on printed articles, such as menus.

The network-based system may also include a database that stores a plurality of menu descriptions created via the web-based application for each of a plurality of restaurants. The network-based system may also include a data mining module. The data mining module can analyze the plurality of menu descriptions to forecast demand levels of food items associated with specific menu items. Well-known forecasting algorithms can be used to analyze the data. In one embodiment, the algorithms look at patterns or sequences of orders over time, over users, and/or over geographic regions to predict demand levels.

The menu descriptions may be any content element 252 described above with respect to FIG. 4. In some embodiments, the menu descriptions include artwork, graphics, photographs, templates, menu templates, data, names, addresses, prices, and/or inventory. The set of rules can include an access right to control which of a plurality of users 262 may have access to at least one of the menu descriptions.

The system may also include a rules optimization engine. The rules optimization engine suggests the set of rules utilized by the system based at least in part upon data stored in the database. In one embodiment, the rules optimization engine suggests the set of rules based at least in part upon the data stored in the database where the data is the inventory levels of menu item components.

For example, the rules optimization engine may analyze the inventory levels of menu item components (which may be stored in the database), and suggests a rule for printed article creation based at least upon the inventory level. For example, in one embodiment, the database indicates that there is a large level of inventory of a particular menu item component, such as hamburger meat. Therefore, the rules optimization engine suggests a rule that at least one item to be displayed on the printed article (e.g., a menu) include hamburger meat (e.g., hamburger, meatloaf, etc.). Furthermore, the rule may require that individual users (e.g., users 262a-262e), which may be restaurant franchisees, include a particular menu item or require that the users 262a-262e include a menu item that includes the inventory item having a large inventory level (e.g., hamburger meat).

In another embodiment, the system also includes an association rules and mining module. The association rules and mining modules can suggest a location on the menu where the selected menu item descriptions are to be displayed. The suggestion can be based at least in part upon the data stored in the database. For example, if the database shows that there is a high inventory of hamburger meat, the association rules and mining module may suggest placing an advertisement for a hamburger meat-containing product at a prevalent or preferred location on the menu.

In another embodiment, the web-based application program suggest an inventory item supplier based at least partially upon the region within which the user is located and the selected menu item description. For example, the web-based application program can identify the city, state, town, or address of the user 262, and suggest a supplier or manufacturer of the selected inventory item within a nearby geographic region.

In another embodiment, rules from the set of rules or the set of rules itself is selected based upon particular rule criteria. For example, the rule criteria may be based upon a geographical region, a user type, and/or user size. The geographical region can include the address, region, state, country, or city. The user type can include whether the user is a franchisor, a franchisee, a user having administration-level privileges, a user having a particular level of administration-level privileges or a client. The user type can include full-service restaurants and express restaurants, and all other user types. In another embodiment, the rule criteria are arranged within a hierarchy.

Reporting

Referring again to the embodiment of FIG. 5, the system 270 can also include a reporting program 282 that provides a report to the administrator regarding transactions performed by the individual users. For example, the administrator may be a restaurant franchisor, and the individual users may be restaurant franchisees. The individual restaurant franchisees can access the system 270 through the publishing network 260 and order their printed articles 250 pursuant to a marketing campaign designed and/or required by the administrator/franchisor.

The reporting program 282 can provide a report to the franchiser as to the printed article ordering activities of its franchisee. Such an arrangement allows more efficient communication and direct communication between the franchisees and the publishing network and does not require the franchiser to be involved in the printed article ordering process. However, even though it is not involved in the printed article ordering process, the franchisor is informed of the franchisee's activities by receiving printed reports from the reporting program 282 of the system 270.

The report may include a demand forecast based upon actual usage of the users 262a-262e. The report may also include customer usage information related to the selected menu item description selected by the user. For example, the franchisor may be able to see or receive a report that indicates which items are being ordered more frequently by the restaurant franchisees, or which items are being selected more or less frequently for placement on printed articles.

Data Mining

In another aspect of the present invention, the system 270 can include one or more software, hardware and/or firmware modules to mine, analyze, collect, and/or organize data received and generated as a result of system 270 use. For example, during system utilization multiple users can place orders for various printed articles, as described in greater above. Users can also provide additional information to the system 270, such as the user's identity, the date an order is placed, quantities, delivery addresses, etc. In one aspect, the system 270 can mine this and other data and provide a report or other communication to authorized system users.

Any data, such as business data, can be utilized and/or analyzed by the system 270. Business data includes any data related to the business associated with a printed article. For example, business data can include sales information, expenditures, financial information, revenue associated with particular products, average selling price, cost of goods sold, accounting data, inventory data, projection data, financial data, and/or any other data.

For example, a client corporation can utilize the system 270 to allow its sales people to order printed materials for sales and marketing purposes. The system 270 can be configured to allow individual sales people to independently place orders for various printed items, such as business cards, sales brochures, posters and give-away items, such as pens, t-shirts, mugs, etc. The system 270 can provide the management of the client corporation with a report of user activity to indicate which sales people are more or less active. For example, the system 270 can provide the management with a report of the number of business cards ordered, sales brochures shipped, etc.

The system 270 can also mine or analyze the data collected by the system 270 based upon the normal usage of its users. Analysis results can be provided to users in any of a variety if formats to provide information relevant to the particular user. For example, management of a user that is a client corporation can identify which products in its catalog are in greatest demand or interest based upon requisitioned literature packages related to those products.

In addition, the system 270 can be adopted to build customer profiles based upon mined data. For example, the system 270 can determine or build a customer profile based upon literature for particular goods and services requested by or shipped to the user. For example, in the healthcare services industry, the system 270 can identify that more literature packages relevant to senior citizen healthcare plans are requested over non-senior citizen healthcare plans and therefore determine that the user is a senior citizen or that the user would more likely be interested in additional senior citizen literature, advertising, or other related items.

In addition, the system 270 can be configured to correlate sales of particular products to the amount of or versions of particular literature or other printed articles related to those products. For example, the system 270 can determine that when menus displaying a hamburger with catsup dripping off its side were ordered from the system 270, that hamburger sales subsequently increased in a period following the order of those printed items that included the hamburger picture. In this regard, the system 270 can provide a method of conducting marketing research based upon data mining of data collected and stored by the system 270. In addition, the system 270 can also analyze system usage data to create visual indicators of trends and relationships between various data within the system 270. For example, the system 270 can display a graph of product sales versus the number of brochures sent related to a particular product.

In some cases, the data processed, collected and/or analyzed by the system is not stored locally. For example, order data, product sales data, etc., can be located or stored in databases on servers and computer remote from the publishing system 270. In such cases the system 270 can include an interface to retrieve such data. The interface can be implemented in hardware, software, firmware, or a combination thereof.

Order Consolidation

The system 270 can also provide back-end consolidation and processing functionality. For example, orders placed by multiple parties for goods to be shipped to the same location can be consolidated and shipped together. In addition, the system 270 can flag orders that might be duplicates of each other and request confirmation from an order placed from a user. For example, if a user places a first order and then at a later time places a second order identical to the first order, prior to completing the order entry process, the user may be requested to confirm that this is not an inadvertent duplicate order of the first order.

The system 270 can also synchronize production to either back orders or to coordinate production so that goods are all ready to ship at about the same time. For example, if an order is placed for two different items and it takes a first time period to produce the first item and a second time period to produce the second item, production will be coordinated so that production is completed at about the same time based upon the different production requirement times. For example, if it takes a week to produce a window banner and a day to produce a table topper, production of the window banner and table topper will be initiated at the appropriate time so that their production is completed at about the same time so these items can be shipped together at the same time thereby saving on shipping costs and time. Similarly, if multiple users from the same office place orders, the production of the goods of the different orders can be coordinated so that they are completed at about the same time so that they can both be shipped to the two users at the same office in one or at least a minimized number of shipments. The system 270 can be set up to provide this functionality if the goods would be shipped in the same container or packaging material. For example, if the size of the items on a particular order would not be shippable in the same container, then production synchronization would not occur.

The system 270 can also be configured to provide order status and/or tracking information related to user orders. For example, the system 270 can use data stored in the system 270 or accessible through the system 270 as well as other external sources in communication with the system 270 over a network to display the status of order production and shipping. For example, in order to complete an order, raw materials may need to be procured from outside sources. Raw materials can include any items upon which printing is to occur such as, paper, cardboard, tube stock, T-shirts, mugs, pens, and/or any medium on to which printing may occur as is well known to those of skilled in the art.

A shipping company can provide shipment tracking data to the system 270 which can be relayed by the system 270 to the user. In one embodiment, all the data or selected portions of the data, including the status and tracking data, is processed by the system 270 and displayed to the user at one location. For example, when an order is placed by the user, raw materials may need to be ordered and received by the production facility. After the supplier of the raw material ships the materials to the production facility, the estimated delivery date of the raw materials to the production facility can be shown along with the estimated production time shipping date of the finished goods and the delivery date of the finished goods to the user. In another implementation, after a product is produced and shipped, a shipping company's tracking information is displayed through the system 270 and provided to the user. For example, the system 270 can be configured such that as soon as the user logs in, the shipping company's tracking information is displayed on the log in screen. In such implementations, the user would not need to “click through” to the shipping company's website to obtain shipping company delivery information. The system 270 can also be configured to send email notifications to users at various stages of order fulfillment, production and/or shipping.

Additional Embodiments

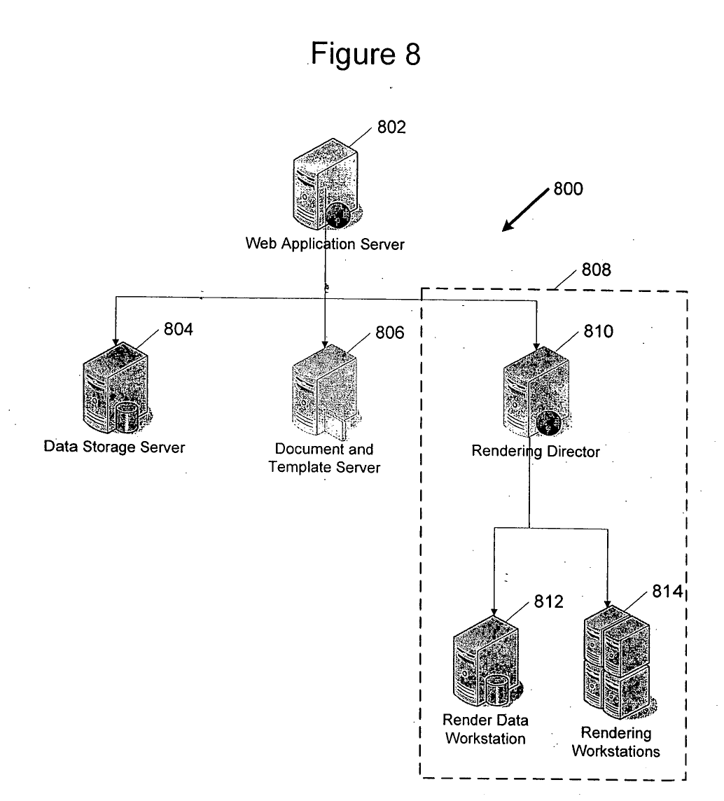

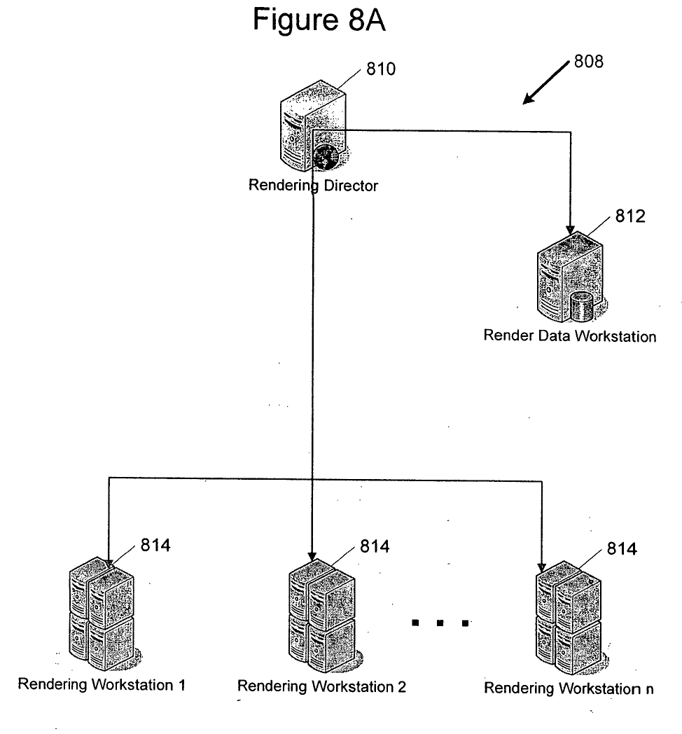

FIG. 8 illustrates a publishing system 800 configured in accordance with another embodiment of the present invention. The publishing system 800 can be used instead of or in combination with the publishing server 104 described above with respect to FIGS. 1 and 2. In the present embodiment, the publishing system 800 includes a web application server 802, a data storage server 804, a document and template server 806, and a rendering system 808. The rendering system 808 generally includes a rendering director 810, a render data server 812, and at least one rendering workstations 814. Although the rendering system 808 of FIG. 8 includes only one rendering workstation 814, any number of rendering workstations 814 can be included, as will be described in greater detail below with respect to FIG. 8A.

In the illustrated embodiment, the publishing system 800 is designed to interface with an accounting system, such as accounting system 124 described above with respect to FIG. 2. In addition, the publishing system 800 can interface with any accounting system or enterprise resource planning (ERP) system known to those of skill in the art. An interface module, such as an interface middleware software module, may be provided to facilitate communication and transfer of information between the publishing system 800 and an accounting or ERP system.

In other cases, an accounting or ERP system is included with the publishing system 800. Sometimes an accounting or ERP system is in direct communication with the publishing system 800. Other times the publishing system 800 does not interface with and is not in communication with an accounting or ERP system. Accounting and ERP systems can provide addition inventory management functionality.

Although the components of the publishing system 800 are described as servers, it should be understood to those of skill in the art that any of a variety of hardware, software, firmware, or combination of hardware, software and firmware components can be used for any of the publishing system 800 components. For example, the publishing system 800 can include servers, workstations, subsystems, modules, databases, or any combination thereof as desired. In addition, if the components of the publishing system 800 generally correspond to or can be substituted for the subsystems of the publishing server 104 described above with respect to FIG. 2.

In the illustrated embodiment of FIG. 8, the web application server 802 is a computer that executes a web application program. Any web application program known to those of skill in the art can be executed by the web application server 802. For example, the web application server 802 can run the .NET application server program (e.g., NET VI 1.1).

The data storage server 804 is any computer capable of providing database communication between multiple servers. For example, in the illustrated embodiment, the data storage server 804 is a Microsoft SQL server. Alternatively, the data storage server 804 can run Oracle software or any other database server software.

The document and template server 806 is a computer adapted to store and provide documents and templates stored on the document and template server 806 to the other components of the publishing system 800. For example, the document and template server 806 can execute any file sharing software known to those of skill in the art. The document and template server 806 could be or included in one or more than one machines, servers, workstations, computers, computational devices, memory storage devices, etc., well known to those of skill in the art.

The rendering director 810 is a computer adapted to execute software to control the rendering of an image by the rendering workstations 814 working in combination with the render data server 812. The render data server 812 is a computer adapted to store data and share it over a network with the rendering director 810 and rendering workstations 814 as required. The rendering workstations 814 include computers with processors capable of executing rendering software residing on the rendering workstation.

Although the components of the publishing system 800 are illustrated as separate discrete components in FIG. 8, it is well understood by those of skill in the art that any or all of the components of the publishing system 800 can be combined in one or more workstations or other component. For example, in other embodiments, the functionality of the web application server 802, data storage server 804, and document and template server 806 are provided by just one server or workstation or other suitable component as described above. In other embodiments, all of the components of the publishing system 800 are combined into a single server.

The web application server 802 serves up all of the web pages of the publishing system so that the publishing functionality of the publishing system is available to users over a network such as, for example, the Internet. Users can log into the publishing system by way of the web application server 802. The data storage server 804 serves as or includes a card catalog or index of the items stored on the document and template server 806. For example, the data storage server 804 includes an index of all or some of the documents, templates, saved customized proofs, or any other document stored on the document and template server 806.

The document and template server 806 includes, among other things, templates that correspond to catalog items displayed by the web application server 802 to publishing system users. For example, when a user logs on to the publishing system and desires to view a catalog of items available to be ordered, the items available for ordering are retrieved from the document and template server 806. In addition, when a particular display item is able to be customized by a user, a template corresponding to that customizable item is also stored on the document and template server 806.

During the process of ordering a customizable product, a user will be given the opportunity to view a proof, as will be described in greater detail below. In order to generate a proof, or preliminary view of what the final customized produce will look like, information relating to the customized order is provided to the rendering system 808.

In the illustrated embodiment of FIGS. 8 and 8A, the rendering director 810 of the rendering system 808 is a server that functions as a web service. For example, the rendering director 810 can function as an ASP .Net web service. The rendering director 810 is in communication with a render data server 812. Logic inside of the render server 812 keeps track of all of the rendering workstations 814 of the rendering system 808. For example, the render data server 812 maintains a log of the status of each of the rendering workstations 814, such as whether it is being checked out or used for a job, whether it has reported an error message, or whether the rendering workstation 814 is available to be checked out for a job.

A request to render an image is received by the rendering director 810 of the rendering system 808. The rendering director then determines from the render data server 812 which rendering workstation 814 is available to render the requested image. The rendering director 810 then, having also received relevant document and template and data information from the web application server 802 and/or document and template server 814, sends that information to the appropriate rendering workstation 814. The rendering workstation 814 generates or renders an image of the customized item and returns that image back to the web application server 802 through the rendering director 810. However, if the rendering workstation 814 fails in rendering the image for any reason, the render data server 812 is notified of the failure and is also notified of the last function performed by the rendering workstation 814. In addition, the user is also notified of the failure of the rendering workstation 814 to generate the rendered image and is given the opportunity to try again.

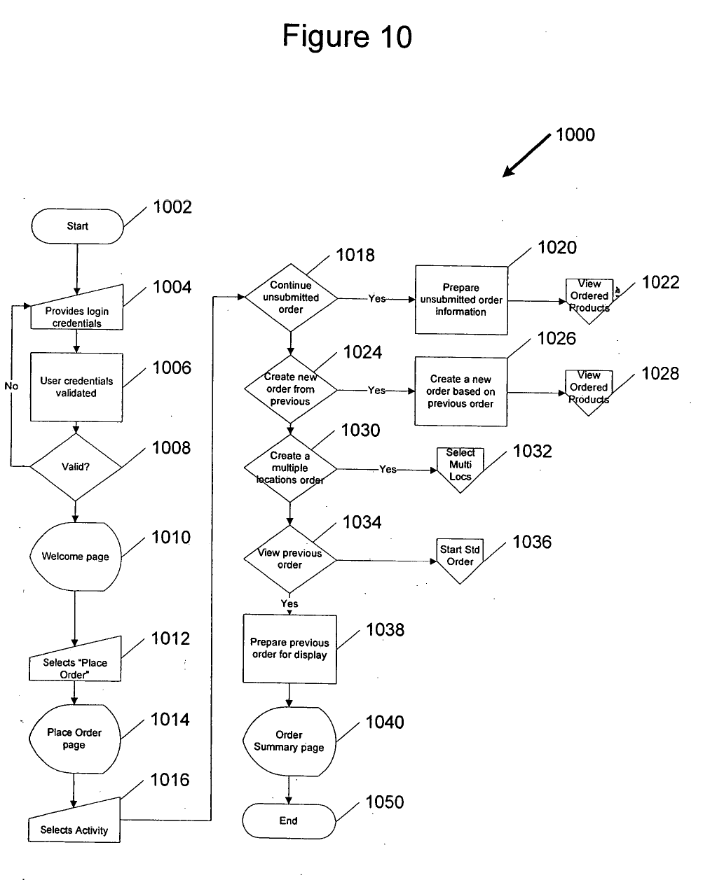

In other embodiments, when the rendering workstation fails, the rendering director 810 automatically provides the rendering request to the next available rendering workstation 814 as determined by the render data server 812. This and other functionality of the rendering system and overall order entry and processing system is described in greater detail below with respect to FIGS. 10 through 17.

Scalability

The number of rendering workstations 814 used by the rendering system 808 can be modified to accommodate system usage and user demand. In some cases the rendering system 808 includes 1, 2, 4, 16, 64, or 128 rendering workstations 814. In other cases, the rendering system 808 includes at least one or at least 4 rendering workstations 814.

The scalable architecture of the rendering system 808 allows any number of rendering workstations 814 to be added to increase system performance. In addition, the architecture of the rendering system 808 can be dynamically modified. For example, additional rendering workstations 814 can be added to or removed from the rendering system 808 without taking the publishing system 800 offline. If system usage increases, additional rendering workstations 814 may merely be “plugged into” or linked into the rendering system 800 network. Similarly, if a rendering workstation 814 fails or otherwise needs to be taken off line, it may merely be disconnected from the rendering system 808 without first taking the publishing system 800 offline.

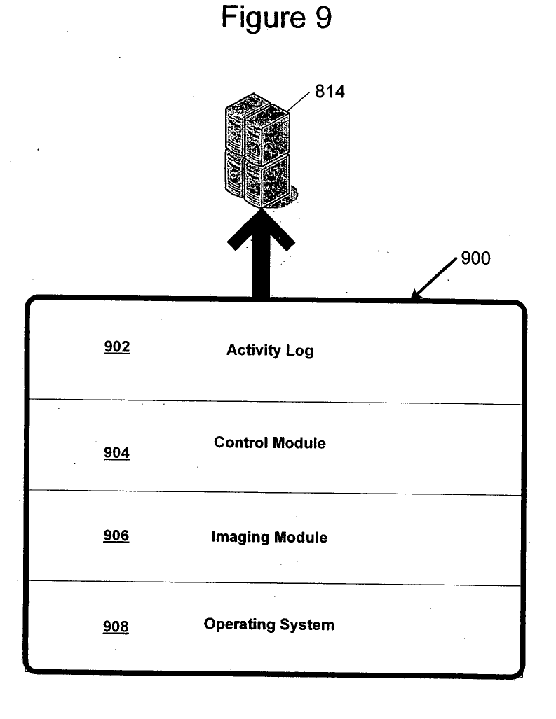

One embodiment of the software system 900 executed by the rendering workstation 814 of FIGS. 8 and 8A is illustrated in FIG. 9. The software system 900 generally includes an activity log 902, a control module 904, an imaging module 906, and an operating system 908. Although the components of the software system 900 are illustrated as separate or discrete components, it is well understood by those of skill in the art that any or all of the components can be combined or integrated as only one, two, three, or any desired number of software components. In addition, additional or fewer software components of the software can be included in the software system 900, as will be well understood by those of skill in the art.

FIG. 10 illustrates a publishing method 1000 able to be performed by the publishing system 800 of FIG. 8. The publishing method 1000 begins at step 1002, where the home page of a publishing system is sent to a user. For example, at step 1002 the home page can be sent to the user after an HTTP request is received from a web browser. At step 1004, the system receives log-in credentials from the user. At step 1006, the system validates the user credentials received at step 1004. At step 1008, the system determines if the log-in credentials are valid. If the log-in credentials are not valid, the method 1000 returns to step 1004. If the log-in credentials are valid, the method 1000 proceeds to step 1010 where the method 1000 displays a welcome page to the user.

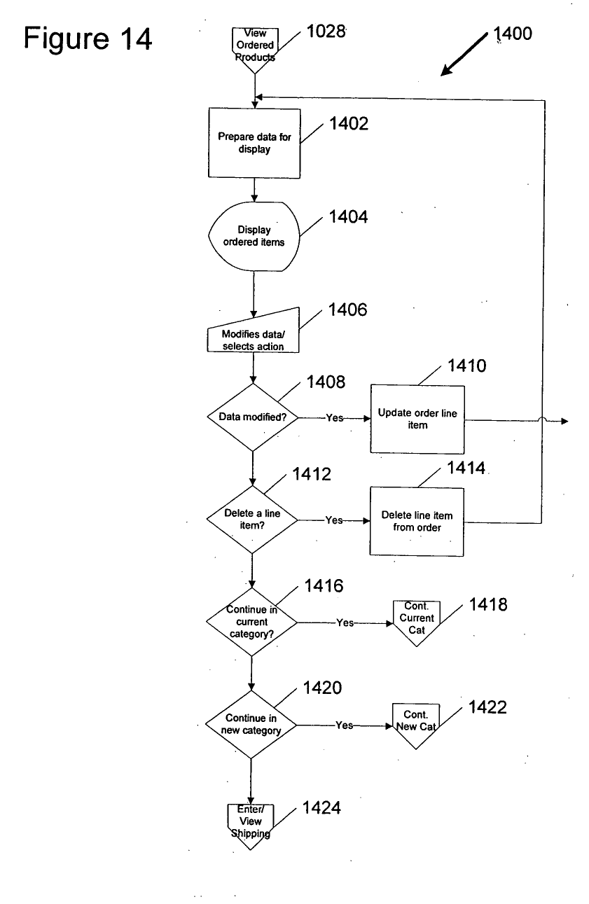

At step 1012, the system receives a selection made by the user. For example, at step 1012, the system can receive a selection corresponding to a “place order” command selected by the user. This can correspond to the user desiring to place an order of printed goods. The method then proceeds to step 1014 where the system provides a “place order” web page to the user. At step 1016, the system receives a selection of an activity specified by the user. At step 1018, the method 1000 determines if the activity selected is to continue to work on and/or finalize an unsubmitted order. If so, the method proceeds to step 1020 where the system prepares unsubmitted order information. At step 1022 the system jumps to step 1402 of the method for displaying ordered products 1400 described in greater detail below with respect to FIG. 14.

If at step 1018 the method 1000 determines that the selected activity was not to continue to work on and/or finalize an unsubmitted order, the method 1000 proceeds to step 1024. At step 1024, the method 1000 determines if the selected activity was to create a new order from a previous order. If so, the method continues to step 1026 where the system creates a new order based on a previous order. Then, at step 1028, the method 1000 jumps to step 1402 of the method for displaying ordered products 1400 described in greater detail below with respect to FIG. 14.

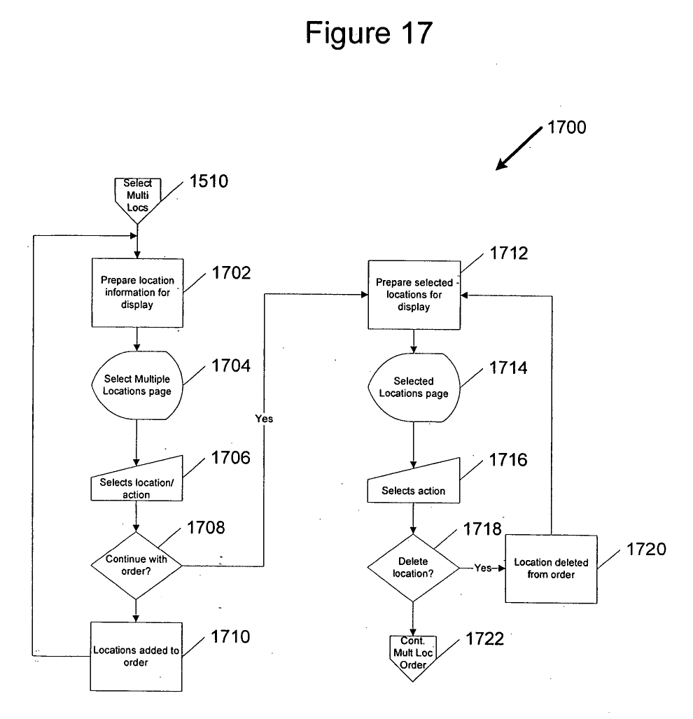

If at step 1024 the method 1000 determines that the selected activity was not to create a new order from a previous order, the method 1000 continues to step 1030. At step 1030, the method 1000 determines whether the selected activity was to create a multiple locations order. If so, the method continues to step 1032 where the method 1000 jumps to step 1702 of the method of processing an order from multiple locations 1700 described in greater detail below with respect to FIG. 17.

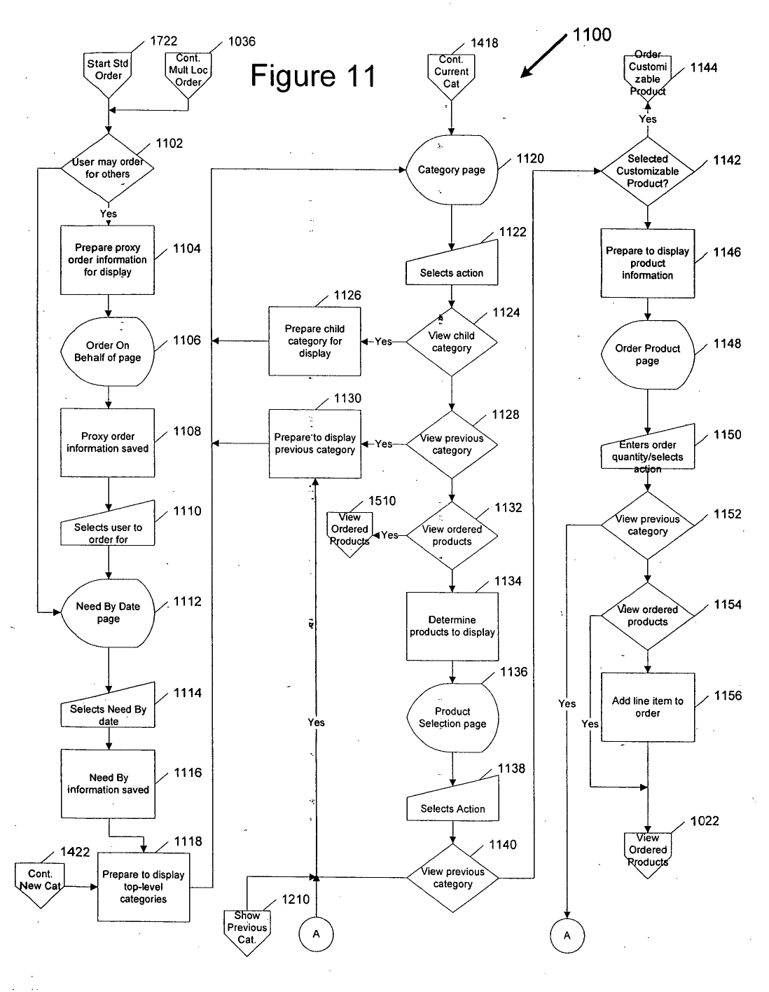

If, however, at step 1030 the method 1000 determines that the selected activity was not to create a multiple locations order, the method 1000 proceeds to step 1034. At step 1034, the method 1000 determines if the selected activity was to view a previous order. If not, the method continues to step 1036, where the method then continues to step 1102 of the method of processing a standard order 1100 described in greater detail below with respect to FIG. 11.

If at step 1034, the method 1000 determines that the selected activity was to view a previous order, the method 1000 continues to step 1038. At step 1038, the system prepares the previous order for display. At step 1040, the system provides an order summary page to the user and the method 1000 ends at step 1050.

FIG. 11 illustrates a method of processing an order 1100 with the publishing system 800 of FIG. 8. The method 1100 begins at step 1102 where the system determines whether the user has privileges or rights to place an order for other individuals or other users. If the system determines that the user does not have such privileges, the method jumps to step 1112. However, if the user does have privileges to place orders for other users, the method continues to step 1104.

At step 1104, the system prepares proxy order information for display. Then at step 1106, the system provides an “order on behalf of” web page to the user. At step 1108, the system saves the proxy order information provided by the user. At step 1110, the system receives an indication of the identity of the user for which the order is being placed. At step 1112, the system provides a “need by date” web page to the user, where the user has the ability to provide a deadline by which the ordered materials must be received by the user. At step 1114, the system receives a need by date selected by the user. At step 1116, the system saves the need by information.

Several of the steps provided by the method 1100 are optional, and in some cases are not performed. For example, the “order on behalf of” and “need by date” functions described above are sometimes not performed by the method 1100. In other cases, these functions are provided based upon administrative settings or privileges assigned to the user.

At step 1118, the system prepares to display top level categories. Top level categories include the first layer of items displayed to a user in an on-line catalog that has at least one layer of catalog items. At step 1120, the system provides a “category page” to the user. At step 1122, the system receives a selected action from the user. At step 1124, the system determines if the selected action was to view a child category. If so, the method 1100 continues to step 1126 where the system prepares child category information for display. The method then returns to step 1120. If, however, at step 1124 the selected action was not to view a child category, the method 1100 continues to step 1128, where the system determines whether the selected action was to view a previous category. If so, the method 1100 continues to step 1130 where the system prepares to display previous category information. The method 1100 then returns to step 1120, as described above.

If, however, at step 1128 the method 1100 determines that the selected action was not to view a previous category, the method 1100 continues to step 1132 where the system determines if the selected action was to view ordered products. If so, the method 1100 jumps to step 1402 of the method of displaying ordered products 1400 described in greater detail below with respect to FIG. 14.

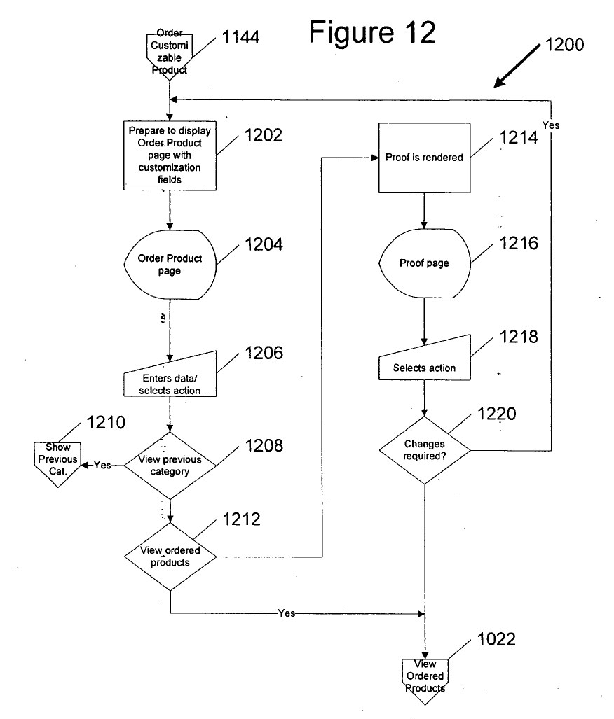

If at step 1132 the system does not determine that the selected action was to view ordered products, the method 1100 continues to step 1134. At step 1134, the system determines which products to display to the user. At step 1136, the system displays a “product selection” page. At step 1138, the system receives an action selected by the user. At step 1140, the system determines if the selected action was to view a previous category. If so, the method 1100 returns to step 1130 as described in greater detail above. If, however, the system determines at step 1140 that the selected action was not to view a previous category, the method 1100 continues to step 1142. At step 1142, the method 1100 determines if the selected action was to select a customizable product. If so, the method 1100 continues to step 1144, where the method jumps to step 1202 of the method of ordering a customizable product 1200 described in greater below with respect to FIG. 12.

If, however, at step 1142 the system determines that the selected action was not to select the customizable product, the method 1100 continues to step 1146. At step 1146, the system prepares to display product information to the user. Then, at step 1148, the system displays an order products page to the user. At step 1150, the system receives an order quantity or selected action from the user. At step 1152, the system determines if the order quantity or selected action was to view a previous category. If so, the method returns to step 1130 as described in greater detail above. If not, the method 1100 continues to step 1154. At step 1154, the method determines if the order quantity or selected action was to view an ordered product. If so, the method proceeds to step 1022 in which the method jumps to step 1402 of the method of displaying ordered product 1400 described in greater detail below with respect to FIG. 14. If, however, the method 1100 at step 1154 determines that the order quantities or selected action was not to view an ordered product, the method continues to step 1156. At step 1156, the system adds a line item to the order and then proceeds to step 1022 described above.

FIG. 12 illustrates a method of ordering a customizable product 1200 with the publishing system 800 of FIG. 8. The method 1200 begins at step 1202 where the system prepares to display an order product page with customization fields. At step 1204, the system provides the order product page to the user. At step 1206, the system receives a data entry or a selected action. At step 1208, the system determines whether the received data or selected action corresponds to a command to view a previous category. If so, the method 1200 continues to step 1210 in which the method 1200 jumps to step 1130 of the processing standard order method 1100 described in greater detail above with respect to FIG. 11.

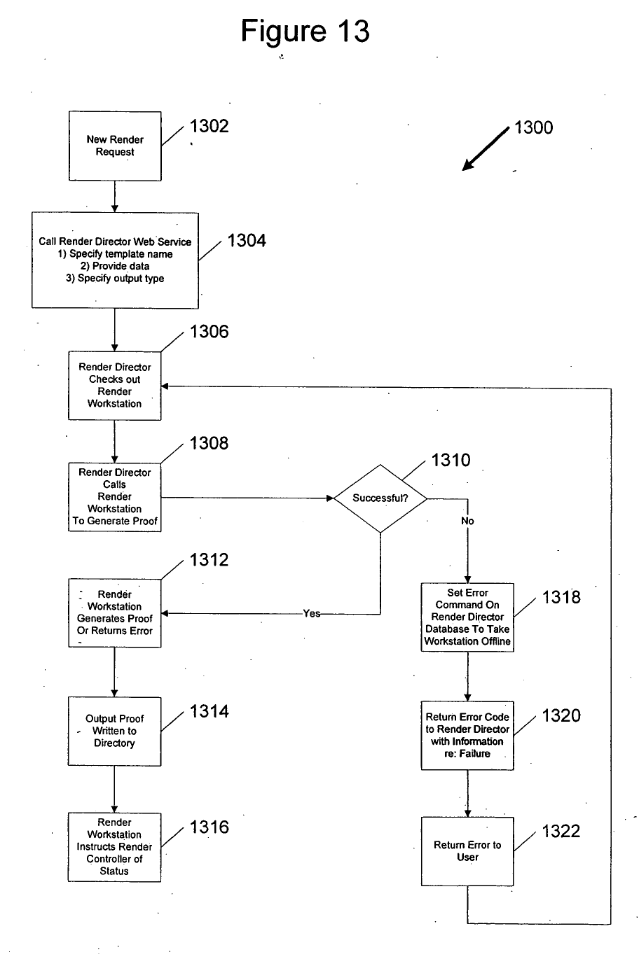

If not, the method continues to step 1212. At step 1212, the method 1200 determines if the data or selected action received from the user at step 1206 corresponds to a command to view an ordered product. If so, the method continues to step 1022 in which the method 1200 jumps to step 1402 of the method of displaying ordered products 1400 described in greater detail below with respect to FIG. 14. If not, the method 1200 continues to step 1214. At step 1214, the system renders a proof. Rendering a proof can include creating an image of what the finished ordered product will look like once produced. In one embodiment, the proof is rendered at step 1214 with the rendering method 1300 described in greater detail below with respect to FIG. 13.

With reference to FIG. 12, the method 1200 continues to step 1216 in which a proof page is provided to the user. At step 1218, the method 1200 receives an action selected by the user. At step 1220, the method 1200 determines if changes to the customized product are required or desired by the user. If so, the method returns to step 1202. If not, the method 1200 continues to step 1022 in which the method 1200 jumps to step 1402 of the method of displaying ordered products 1400 described in greater below with respect to FIG. 14.

FIG. 13 illustrates a rendering method 1300 able to be performed by the publishing system 800 of FIG. 8. The rendering method 1300 begins at step 1302 in which the system receives a render request. At step 1304, the system calls a render director web service to specify a template name, provide data and specify the output type. Additional details regarding templates, data that can be specified to fill in the fields of the template, and the output types were described in greater detail above. In some cases, the template names correspond to various printed goods, such as menus, business cards, form letters, brochures, etc. The data provided at step 1304 can include any type of data including graphics, text, pictures, colors, etc. The output type is generally any type of output image format such as, for example, .pdf, .ps, .jpeg, or .eps files.

The method 1300 then continues to step 1306 where the render director checks out a render workstation. At step 1308, the render director calls the render workstation to generate a proof. At step 1310, the system determines whether the render workstation successfully generated the proof. If so, the method continues to step 1312 where the render workstation generates the proof. At step 1314, the proof generated by the render workstation is written to a directory. At step 1316, the render workstation instructs the render controller of its status.

If, however, at step 1310 the render workstation was not successful in generating a proof, the method 1300 continues to step 1318. At step 1318, an error command is set on the rendered director database to take that workstation offline. Then, at step 1320, the system returns an error code to the render director with information regarding why the workstation failed. At step 1322, an error message is provided to the user to inform the user that the system was unable to generate the render request. Then, the method can terminate or jump to step 1202 of the method of ordering a customizable product 1200 described in greater detail above with respect to FIG. 12. Alternatively, the method 1300 can return to step 1306 of the rendering method 1300 and repeat the method 1300 to try to generate a proof with a different workstation.

FIG. 14 illustrates a method of displaying ordered products 1400 able to be performed by the publishing system 800 of FIG. 8. The method 1400 begins at step 1402 where the system prepares data for display. Then, at step 1404, the system sends displays ordered items to the user, for example, via a web page. At step 1406, the system receives a selection from the user. At step 1408, the system determines whether the selection was to modify data. If so, the method 1400 continues to step 1410 where the system updates the order line item. The method 1400 then returns to step 1402.

If at step 1408 the selection does not correspond to data being modified, the method 1400 proceeds to step 1412. At step 1412, the system determines whether a line item was deleted. If so, the method 1400 continues to step 1414 where the system deletes the line item from the order. The method 1400 then returns to step 1402.

If, however, at step 1412 the system determines that the user selection does not correspond to deleting a line item, the method 1400 continues to step 1416. At step 1416, the method 1400 determines if the selection was to continue in the current category. If so, the method continues to step 1418 in which the method 1400 jumps to step 1120 of the method of processing a standard order 1100 as described in greater detail above with respect to FIG. 11.

If, however, at step 1416 the method 1400 determines that the user selection was not to continue in the current category, the method 1400 continues to step 1420. At step 1420, the method 1400 determines if the selection was to continue in a new category. If so, the method continues to step 1422 in which the method then jumps to step 1118 of the method of processing a standard order 1100 described in greater detail above with respect to FIG. 11. If not, the method 1400 continues to step 1422 in which the method jumps to step 1502 of the method of processing shipping information 1500.

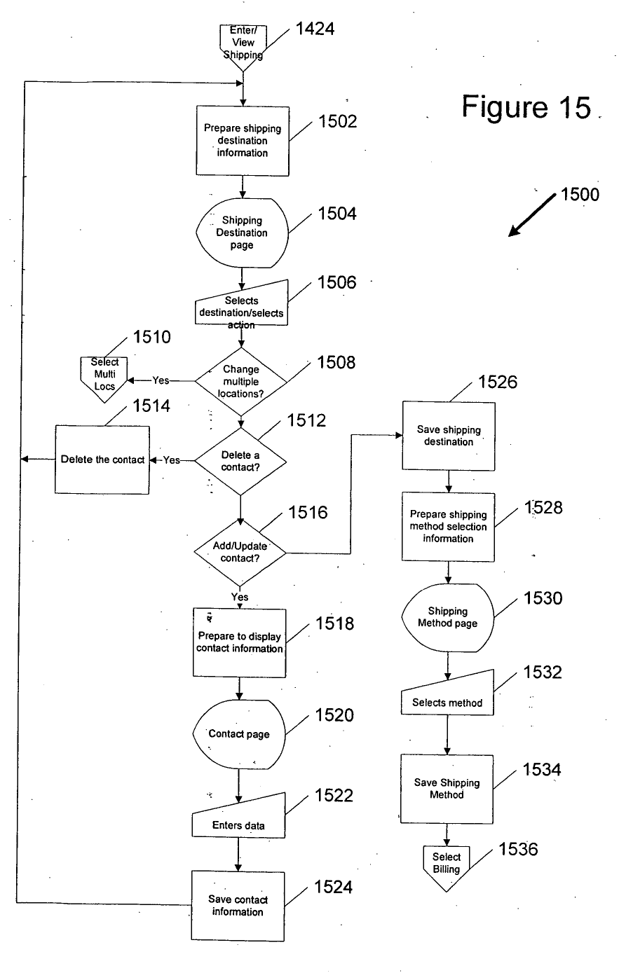

FIG. 15 illustrates a method of processing shipping information 1500 able to be performed with the publishing system 800 of FIG. 8. The method 1500 begins at step 1502 in which the system prepares shipping destination information. The shipping destination information is then provided to the user on a “shipping destination” page provided to the user at step 1504. At step 1506, the system receives a selection by the user that corresponds to a shipping destination or a selection of an action.

At step 1508, the method 1500 determines if the user selection was to change multiple locations. If so, the method 1500 continues to step 1510 in which the method 1500 jumps to step 1702 of the method of processing an order from multiple locations 1700 described in greater detail below with respect to FIG. 17.

If not, the method 1500 continues to step 1512 in which the method determines if the user selection was to delete a contact. If so, the method 1500 continues to step 1514 in which the system deletes the contact information. The method 1500 then returns back to step 1502. If, however, at step 1512 the user selection was not to delete a contact, the method continues to step 1516.

At step 1516, the method 1500 determines if the user selection was to add or update contact information. If so, the method continues to step 1518. At step 1518, the system prepares to display contact information. At step 1520, the contact information is provided to the user on a contact page. At step 1522, the system receives data entry from the user. At step 1524, the data entered by the user at step 1522 is saved. The method 1500 then returns to step 1502.

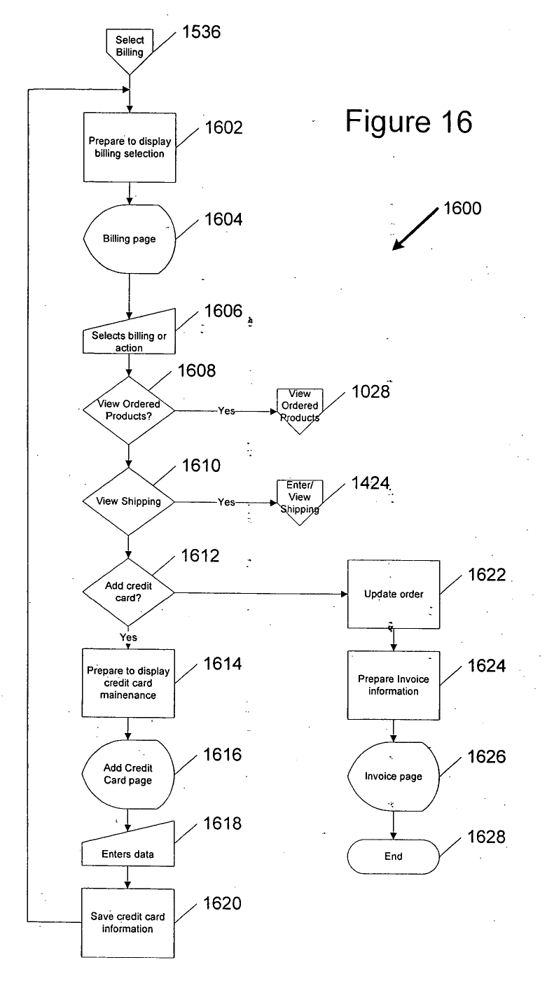

If, however, at step 1516 the user selection was not to add or update contact information, the method continues to step 1526. At step 1526, the system saves shipping destination information. At step 1528, the system prepares the shipping method selection information and displays the shipping method page at step 1530. At step 1532, the system receives user selection regarding to a shipment method. At step 1532, the system saves the shipping method information. Then, at step 1536, the method jumps to step 1602 of the method of processing billing information 1600 described in greater detail below with respect to FIG. 16.

In some cases, billing rates are determined based upon a selected shipping vendor's customer-specific rates. For example, if a user has a shipping account with a selected shipping company (e.g., Federal Express, Inc.), the method 1500 can determine the user's shipping billing rate as provided by the selected shipping company. In one case the method 1500 accesses the shipping company's shipping web service application program interface (“API”) to determine the shipping rate for the user based upon the user's account number.

FIG. 16 illustrates one method of processing billing information 1600 able to be performed with the publishing system 800 of FIG. 8. The method 1600 begins at step 1602 where the system prepares to display billing selection information. At step 1604, the system provides a billing page displaying the billing selection information.

The method 1600 can processing billing information from a variety of billing information sources. For example, in some cases, the method 1600 processes a user's credit card information that is either entered by the user, or stored in the system and related to the user. In other cases, the method 1600 processes orders based upon account information stored within the system. Sometimes the method 1600 processes billing information received from a purchase order, or from a combination of billing information sources. For example, if a user has been assigned a particular credit limit and the user places a purchase order that exceeds that limit, the method 1600 can process the order against the purchase order to the extent of the credit limit and request credit card information and/or authorization for the balance.

At step 1606, the system receives a selection from the user corresponding to billing or some other actions. At step 1608, the system determines if the user selection was to view an ordered product. If so, the method 1600 continues to step 1028 in which the method jumps to step 1402 of the method of displaying ordered products 1400 described in greater detail above with respect to FIG. 14.

If not, the method 1600 continues to step 1610. At step 1610, the method 1600 determines if the user selection was to view shipping information. If so, the method 1600 continues to step 1424 in which the method 1600 then jumps to step 1502 of the method of processing shipping information described in greater detail above with respect to FIG. 15.

If, however, at step 1610 the system determines that the user did not select to view shipping information, the method 1600 continues to step 1612. At step 1612, the method 1600 determines if the user selection was to add a credit card. If so, the method continues to step 1614 in which the system prepares to display credit card maintenance information. At step 1616, the system provides a credit card page to the user. At step 1618, the system receives information provided by the user and at step 1620, the user information is saved. The method 1600 then returns to step 1602.

If at step 1612 the system determines that the user selection was not to add credit card information, the method continues to step 1622. At step 1622, the system updates the order. At step 1624, the method prepares invoice information and displays the invoice information on an invoice page at step 1626. The method 1600 ends at step 1628.

FIG. 17 illustrates a method of processing an order for multiple locations 1700 able to be performed by the publishing system 800 of FIG. 8. The method 1700 begins at step 1702 with the system prepares location information for display to the user. The location information is provided to the user on a multiple locations page at step 1704. At step 1706, the system receives a selection from the user regarding the location or a particular action. At step 1708, the system determines whether the user selection was to continue with the order. If not, the method 1700 continues to step 1710 in which the location is added to the order and the method 1700 then returns to step 1702.

If, however, at step 1708 the method determines that the user selection was to continue with the order, the method proceeds to step 1712 in which the system prepares selected locations for display. The selected locations for display are provided to the user on a selected locations page at step 1714. At step 1716, the user selects an action and at step 1718, the system determines if the action was to delete a location.

If the user selection was to delete a location, the method 1700 continues to step 1720 in which the location is deleted from the order. The method then returns to step 1712 of the method 1700. If, however, at step 1718 the system determines that the user selection was not to delete a location, the method 1700 continues to step 1722 in which the method 1700 jumps to step 1102 of the method of processing a standard order 1100 described in greater detail above with respect to FIG. 11.

Embodiments described herein provide improved service and cost efficiencies for printed product ordering, production, shipping, tracking and inventory control. In addition, embodiments of the present invention allow users to totally customize printed articles and to control customization by using a rules-based approach to print management. Embodiments provide additional accounting, inventory management (including production and shipping), reporting and data mining functionality as well.

Although this invention has been disclosed in the context of a certain preferred embodiment, it will be understood by those skilled in the art that the present invention extends beyond the specifically disclosed embodiment to other alternative embodiments and/or uses of the invention and obvious modifications and equivalents thereof. In particular, while the present network-based customizing, proofing and publishing system and methods have been described in the context of a particularly preferred embodiment, the skilled artisan will appreciate, in view of the present disclosure, that certain advantages, features and aspects of the information communication system, device, and method may be realized in a variety of other applications and software systems. Additionally, it is contemplated that various aspects and features of the invention described can be practiced separately, combined together, or substituted for one another, and that a variety of combination and subcombinations of the features and aspects can be made and still fall within the scope of the invention. Furthermore, the systems described above need not include all of the modules and functions described in the preferred embodiments. Thus, it is intended that the scope of the present invention herein disclosed should not be limited by the particular disclosed embodiment described above, but should be determined only by a fair reading of the claims that follow.

What is claimed is:

1. A network-based system that provides functionality for controlling the content of a printed article, the system comprising:
an electronic data repository that contains content elements that may be selected to include within printed articles, and contains a set of rules that specify, at least, specific required content elements; and
a web-based application program that provides functionality for a user to interactively create a printed article that includes selected content elements descriptions from the data repository, and to place an order for printed copies of a created printed article, wherein the web-based application inhibits the creation of printed articles that do not comply with the set of rules.

2. The system of claim 1, wherein the printed article comprises a menu.

3. The system of claim 2, wherein the content element comprises a menu item.

4. The system of claim 1, wherein the web-based application includes an administration user interface that provides functionality for an administrator to specify the set of rules.

5. The system of claim 4, wherein said set of rules comprises an access right to control which of a plurality of users may have access to said system.

6. The system of claim 4, wherein said set of rules control the order in which said selected content elements are displayed on said printed articles.

7. The system of claim 1, further comprising:
a database that stores a plurality of content element descriptions created via the web-based application for each of a plurality of user sites; and
a data mining module that analyzes the plurality of content element descriptions to forecast demand levels of items associated with specific content elements.

8. The system of claim 7, wherein said user sites comprise restaurants.

9. The system of claim 7, wherein said items comprise food or drink items.

10. The system of claim 7, wherein said content element descriptions are selected from the group consisting of one or more of the following: artwork, graphics, photographs, templates, menu templates, data, names, addresses, prices, text, and inventory.

11. The system of claim 7, wherein said set of rules comprises an access right to control which of a plurality of users may have access to at least one of said content element descriptions.

12. The system of claim 7, further comprising a rules optimization engine that suggests the set of rules based at least in part upon data stored in said database, wherein said data comprises inventory levels of content element components.

13. The system of claim 7, further comprising an association rules and mining module that suggests a location on said printed article for said selected content element descriptions based at least in part upon data stored in said database.

14. The system of claim 1, further comprising:
a reporting program that provides a report to an administrator regarding transactions performed by the user.

15. The system of claim 14, wherein said report comprises a demand forecast based upon actual usage of a plurality of users.

16. The system of claim 14, wherein said report comprises customer usage information related to the selected content elements selected by the user.

17. The system of claim 1, wherein said web-based application program suggests an inventory item supplier based at least partially upon a region within which the user is located and said selected content elements.

18. The system of claim 1, further comprising an order generator that automatically orders an inventory item based at least partially upon a region within which the user is located and said selected content elements.

19. The system of claim 1, wherein selected rules from said set of rules are applied based upon rule criteria.

20. The system of claim 19, wherein said rule criteria is selected from the group comprising one or more of the following: a geographical region, a user type, and a user size.

21. The system of claim 20, wherein said user type is selected from the group comprising one or more of the following: a full service restaurant and an express restaurant.

22. The system of claim 19, wherein said rule criteria are arranged as a rule hierarchy.

23. The system of claim 1, further comprising a rendering director adapted to control the rendering of an image by at least one rendering workstation, wherein the rendering director provides data to the at least one rendering workstation to generate a proof corresponding to the printed article.

24. A method of controlling the content of a printed article, the method comprising:
providing an electronic data repository that contains content elements that may be selected to include a printed article;
providing a set of rules that specify, at least, specific required content elements;
receiving a selection of at least one of the content elements;
determining if said selection complies with the set of rules; and
generating a data file corresponding to the printed article when said determining indicates that the selection complies with the set of rules.

25. The method of claim 24, wherein the receiving a selection of at least one of the content elements is received from a web-based application program.

26. The method of claim 24, further comprising generating a proof of the printed article.

27. The method of claim 26, further comprising initiating production of the printed article upon receiving an approval of said proof.

28. The method of claim 24, wherein said printed article comprises a menu.

29. The method of claim 28, wherein said content elements comprise menu item descriptions.

30. The method of claim 28, wherein said content elements comprise images of menu items.

31. A method of collecting and aggregating print orders includes the steps of:
retrieving a template corresponding to the printed article, wherein the template includes a plurality of fields that corresponds to the at least one fixed content element and the at least one variable content element;
receiving the at least one fixed content element and the at least one variable content element;
searching a database for an existing version corresponding to the at least one variable content element;
creating a new version within the database when the existing version is not found, wherein the new version corresponds to the at least one variable content element; and
updating a production quantity associated with the existing or new version.

32. The method of claim 31, further comprising receiving a user identification.

33. The method of claim 31, further comprising providing an interface based at least in part upon the user identification.

34. The method of claim 31, further comprising receiving a print order, wherein the print order comprises an order quantity and an article identification corresponding to a printed article, wherein the printed article comprises at least one fixed content element and at least one variable content element.

35. The method of claim 31, further comprising displaying a proof, wherein the proof includes a visual representation corresponding to the template with its fields populated with the at least one fixed content element, and the at least one variable element.

36. The method of claim 31, wherein said receiving the at least one fixed content element and the at least one variable content element comprises receiving from a database.

37. The method of claim 31, wherein said receiving the at least one fixed content element and the at least one variable content element comprises receiving from the user.

38. A method of automatically aggregating orders for printed articles, comprising:
receiving a first order for a first printed article, wherein the first printed article comprises a first set of content elements;
receiving a second order for a second printed article, wherein said second printed article comprises a second set of content elements;
comparing said first and second sets of content elements; and
programmatically aggregating said first and second orders when said first and second sets of content elements are substantially identical.

39. The method of claim 38, wherein the first order comprises a first shipping location and the second order comprises a second location; and
shipping the first order to the first location and the second order to the second location.

40. The method of claim 38, wherein said first printed article comprises a menu.

41. The method of claim 40, wherein said first set of content elements are selected from the group consisting of one or more of the following: a menu item description, a menu item price, artwork, graphics, photographs, templates, menu templates, data, names, addresses, prices, and inventory.

42. The method of claim 38, further comprising generating a production command indicative of said aggregated first and second orders.

43. The method of claim 38, further comprising programmatically coordinating production of said first and second printed articles so that production of said first and second printed articles is completed at approximately the same time.

44. The method of claim 43, further comprising shipping said first and second printed articles together upon production completion.

45. A network-based system that provides functionality for controlling the content of a printed article, the system comprising:
an electronic data repository that contains content elements that may be selected to include within printed articles;
a web-based application program that provides functionality for a user to interactively create a printed article that includes selected content elements from the data repository and to provide order entry data for printed copies of a created printed article; and
an analysis engine program that generates report data based at least in part on said order entry data and provides a report comprising said report data upon request from a user.

46. The network-based system of claim 45, wherein said analysis engine is also capable of generating reports based at least in part upon business data in addition to said order entry data.

47. The network-based system of claim 46, wherein said business data is selected from the group consisting of one or more of the following: sales information, expenditures, financial information, revenue associated with particular products, average selling price, and cost of goods sold.

48. A method of automatically aggregating orders for printed articles, comprising:
receiving a first order for a first printed article, wherein the first order comprises an associated first production completion date and first shipping destination;
receiving a second order for a second printed article, wherein the second order comprises an associated second production completion date and second shipping destination;
comparing said first and second shipping destinations; and
programmatically coordinating a production schedule associated with said first and second orders such that the first and second production completion dates are about equal when said first and second shipping destinations are equivalent.

49. The method of claim 48, further comprising shipping said first and second printed articles to said first shipping destination.
